(19) United States
(12) Patent Application Publication
(10) Pub. No.: US 2026/0228299 A1
(43) Pub. Date: Aug. 6, 2026

(54) PROBLEM SOLVER APPARATUS, PROBLEM SOLVING METHOD, AND COMPUTER PROGRAM PRODUCT

(71) Applicants: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(72) Inventor: Masaru SUZUKI, Ota Tokyo (JP)

(73) Assignees: KABUSHIKI KAISHA TOSHIBA, Kawasaki-shi Kanagawa (JP); TOSHIBA DIGITAL SOLUTIONS CORPORATION, Kawasaki-shi Kanagawa (JP)

(21) Appl. No.: 19/466,978

(22) Filed: Feb. 2, 2026

(30) Foreign Application Priority Data
Feb. 3, 2025 (JP) 2025-016238

(51) Int. Cl. G06F 17/11

(52) U.S. Cl. CPC G06F 17/11

(57) ABSTRACT

A problem solver apparatus includes a hardware processor serving to solve an integer optimization problem of minimizing an objective function under a linear constraint condition. The hardware processor calculates, for each of one or more penalty functions corresponding to one or more inequality constraint conditions, a first parameter to be multiplied on a target penalty function and a second parameter to be multiplied on a square of the target penalty function. The hardware processor generates a fast augmented Lagrange function. The hardware processor outputs, as a solution set for an integer optimization problem, a set of solutions satisfying the linear constraint condition among one or more solutions to the Lagrange function problem.

### CROSS-REFERENCE TO RELATED APPLICATIONS

This application is based upon and claims the benefit of priority from Japanese Patent Application No. 2025-016238, filed on Feb. 3, 2025; the entire contents of which are incorporated herein by reference.

### FIELD

Embodiments described herein relate generally to a problem solver apparatus, a problem solving method, and a computer program product.

### BACKGROUND

As one of optimization problems, a portfolio optimization problem is known. In the modern society, financial products are bought and sold. Furthermore, in the modern society, there are investment targets.

There are unique returns and unique risks for each of the financial products and the investment targets. Furthermore, each of the financial products and the investment targets has a risk correlation with other financial products or investment targets. The portfolio optimization problem is an optimization problem that combines some of financial products and investment targets among the financial products and the investment targets to bring a magnitude of return and a magnitude of risk close to expected values.

Conventionally, a portfolio optimization problem is analytically solved under the following assumption. (1) Investment amounts in a financial product and an investment target are indicated by continuous value decision variables. (2) When the investment amounts in the financial product and the investment target are vectorially represented, returns are indicated by linear functions of the investment amounts. (3) When the investment amounts in the financial product and the investment target are vectorially represented, risks are indicated by quadratic functions of the investment amounts.

However, most of real financial products and investment targets merely approximately satisfy such assumptions. For example, a trading unit of a stock is determined. Therefore, the investment amount for a stock can be set only by an integer multiple of stock price×trading unit. Accordingly, when the investment amount is small, the investment amount for a stock is indicated only by a unit such as one trading unit or two trading units, and, when the investment amount is indicated by a continuous value decision variable, an approximation error becomes large.

Furthermore, since stocks give voting rights to shareholders, as a shareholding ratio is larger, a more return that enables involvement in management is generated. Accordingly, when the investment amount is large, the return is not accurately indicated by a linear function of the investment amount, and needs to be indicated by a more expressive function such as a convex quadratic function or a non-convex quadratic function.

A formula to analytically solve such a portfolio optimization problem in a case where the assumptions of above-described (1), (2), and (3) are not satisfied is not known, and, accordingly, a method for solving such a portfolio optimization problem by numerical calculation is generally adopted for such a portfolio optimization problem.

A mathematical optimization problem is an optimization problem that changes a decision variable (a variable that indicates an unspecified element) within a range of a value range for each decision variable, satisfies a given constraint condition, and maximizes or minimizes an objective function (a function that indicates a scale of desirability).

The mathematical optimization problem is often classified into the following first viewpoint, second viewpoint, third viewpoint, fourth viewpoint, and fifth viewpoint. The mathematical optimization problem is classified in this way because a suitable solution method is different depending on a combination of viewpoints.

The first viewpoint is types of the decision variable. The types of the decision variable include a continuous value decision variable, a discrete value decision variable, an integer value decision variable, and a binary value decision variable.

The continuous value decision variable is a decision variable obtained by defining a value range as a continuous zone. The discrete value decision variable is a decision variable obtained by defining a value range as a set of discrete values. The integer value decision variable is a discrete value decision variable obtained by defining a value range as a set of consecutive integers. The binary decision variable is an integer value decision variable whose value range is a first value (e.g., 0 or −1) and a second value (e.g., 1 or +1).

Note that the discrete value decision variable, the integer value decision variable, and the binary decision variable can be mutually converted, and are often handled without distinction in practical use. For example, an integer value decision variable whose value range is {0, 1, 2, 3, 4, 5, 6, 7} can be indicated by a set of three binary decision variables.

The second aspect is types of the objective function. The types of the objective function include a first-order objective function (linear objective function), a quadratic objective function, and a non-linear objective function.

The first-order objective function is a function indicated by a linear function of a decision variables. The quadratic objective function is a function indicated by a quadratic function of the decision variables. The non-linear objective function is a function indicated by a quadratic or higher-order function of the decision variables. Note that, according to discrete optimization, a cubic or higher-order objective function can be lowered to the quadratic function by adding an auxiliary decision variable and a constraint condition.

The third aspect is types that depend on the number of objective functions. The types that depend on the number of objective functions include satisfaction, single objective optimization, and multi-objective optimization.

Satisfaction is a mathematical optimization problem including zero objective function, and is a problem of searching for a solution that satisfies the constraint condition. The single objective optimization is a mathematical optimization problem including one objective function. The multi-objective optimization is a mathematical optimization problem including two or more objective functions.

The fourth aspect is types of the constraint condition. The types of the constraint condition include unconstrained optimization, linear constrained optimization, quadratic constrained optimization, and non-linear constrained optimization.

The unconstrained optimization is a mathematical optimization problem that does not include the constraint condition. The linear constrained optimization is a mathematical optimization problem whose constraint condition is indicated by a linear equality or inequality. The quadratic constrained optimization is a mathematical optimization problem whose constraint condition is indicated by a quadratic equality or inequality. The non-linear constrained optimization is a mathematical optimization problem whose constraint condition is indicated by a quadratic or higher-order equality or inequality.

The fifth aspect is types of convexity. The types of the convexity include convex optimization and non-convex optimization.

The convex optimization is a mathematical optimization problem all of whose objective functions and constraint conditions satisfy the convexity. The non-convex optimization is a mathematical optimization problem whose one or more objective functions and constraint conditions do not satisfy the convexity.

Note that the linear function obviously has convexity. Hence, the mathematical optimization problem is classified into the fifth aspect when one or more objective functions and constraint conditions are quadratic functions or non-linear functions. Furthermore, some optimization methods are fast in exchange for an application target being limited to convex optimization.

Patent literature JP 7455773 B2 describes a fast solving system that executes linearly constrained mathematical optimization of a binary decision variable and a non-convex quadratic objective function fast.

This fast solving system generates an unconstrained second optimization problem of a binary decision variable and a non-convex quadratic objective function by converting a linear constraint of the linearly constrained first optimization problem of the binary decision variable and the non-convex quadratic objective function into a linear correction term and a quadratic correction term using an augmented Lagrange function method. In this regard, this fast solving system handles, as parameters, λ that is a coefficient to be multiplied on the linear correction term, and μ that is a coefficient to be multiplied on the quadratic correction term. Furthermore, this fast solving system solves the first optimization problem by repeating a first step, a second step, and a third step for the first optimization problem and the second optimization problem.

In the first step, this fast solving system solves the second optimization problem using an Ising solver to obtain a temporary solution. In the second step, this fast solving system evaluates the temporary solution as a solution to the first optimization problem. If an evaluation is not good, this fast solving system adjusts λ and μ using the temporary solution in the third step.

Furthermore, when the evaluation of the temporary solution in the second step is sufficiently good, this fast solving system ends the repetition and outputs a final temporary solution as the solution to the first optimization problem.

In this fast solving system, the Ising solver performs solving every time λ and μ are adjusted, and there has been a problem that a time taken to end adjustment of λ and μ becomes long.

Furthermore, this fast solving system also has had a problem that efficiency at a time of pruning an upper bound and a lower bound of a decision variable lowers in an augmented Lagrange function using adjusted λ and μ. As a result, this fast solving system has had a problem that a probability of obtaining a good solution or an exact solution lowers.

Furthermore, this fast solving system has had a problem that, when adjustment of λ and μ for each of linear constraints interferes, a time required for the adjustment further increases. Furthermore, this fast solving system has had a problem that, when there are partial spaces from which good solutions can be obtained in the solution space, λ and μ vibrate between the partial spaces, and the time required for adjustment further increases.

### BRIEF DESCRIPTION OF THE DRAWINGS

FIG. 1 is a diagram illustrating a functional configuration of a problem solver apparatus according to a first embodiment;

FIG. 2 is a diagram illustrating an example of an objective function and a penalty function in a solving target integer optimization problem according to the first embodiment;

FIG. 3 is a diagram illustrating an example of a general augmented Lagrange function and the penalty function in the solving target integer optimization problem according to the first embodiment;

FIG. 4 is a diagram illustrating an example of information to be stored in a memory according to the first embodiment;

FIG. 5 is a diagram illustrating an example of information to be stored in a storage device according to the first embodiment;

FIG. 6 is a diagram illustrating a functional configuration of a processor;

FIG. 7 is a flowchart illustrating a procedure of processing of the processor according to the first embodiment;

FIG. 8 is a flowchart illustrating a procedure of processing of generating a fast augmented Lagrange function in S12;

FIG. 9 is a flowchart illustrating a procedure of pruning processing in S13;

FIG. 10 is a diagram illustrating an example of a solution space that indicates a Lagrange function problem according to the first embodiment;

FIG. 11 is a diagram illustrating an example of a solution space that indicates a solving target integer optimization problem in a problem solver apparatus according to a second embodiment;

FIG. 12 is a diagram illustrating an example of a general augmented Lagrange function and a penalty function in the solving target integer optimization problem according to the second embodiment;

FIG. 13 is a flowchart illustrating a procedure of processing of a processor according to the second embodiment;

FIG. 14 is a flowchart illustrating a procedure of processing of generating a fast augmented Lagrange function in S42;

FIG. 15 is a diagram illustrating an example of a solution space that indicates a Lagrange function problem according to the second embodiment;

FIG. 16 is a diagram illustrating an example of a solution space that indicates a solving target integer optimization problem in a problem solver apparatus according to a third embodiment;

FIG. 17 is a diagram illustrating an example of a general augmented Lagrange function and a penalty function in the solving target integer optimization problem according to the third embodiment;

FIG. 18 is a diagram illustrating an example of information to be stored in a memory according to the third embodiment;

FIG. 19 is a flowchart illustrating a procedure of processing of a processor according to the third embodiment;

FIG. 20 is a flowchart illustrating a procedure of processing of calculating a solution to a Lagrange function problem for each of clusters in S65;

FIG. 21 is a diagram illustrating an example of a solution space that indicates a Lagrange function problem generated in the problem solver apparatus according to the third embodiment and corresponding to a first cluster; and

FIG. 22 is a diagram illustrating an example of a solution space that indicates a Lagrange function problem generated in the problem solver apparatus according to the third embodiment and corresponding to a second cluster.

### DETAILED DESCRIPTION

A problem solver apparatus according to one embodiment includes a hardware processor connected to a memory. The hardware processor serves to solve an integer optimization problem of minimizing an objective function under a linear constraint condition. The linear constraint condition includes one or more inequality constraint conditions and a target value constraint condition that makes the objective function equal to or more than or equal to or less than a target value. The hardware processor is configured to acquire the integer optimization problem. The hardware processor is configured to calculate a first parameter to be multiplied on a target penalty function and a second parameter to be multiplied on a square of the target penalty function. The first parameter and the second parameter are calculated for each of one or more penalty functions corresponding to the one or more inequality constraint conditions. The hardware processor is configured to generate a fast augmented Lagrange function obtained by adding the objective function, one or more terms multiplied with the first parameter corresponding to each of the one or more penalty functions, and one or more terms multiplied with the second parameter corresponding to a square of each of the one or more penalty functions. The hardware processor is configured to acquire one or more solutions to a Lagrange function problem of minimizing the fast augmented Lagrange function. The hardware processor is configured to output, as a solution set for the integer optimization problem, a set of solutions satisfying the linear constraint condition among the one or more solutions to the Lagrange function problem.

Hereinafter, a problem solver apparatus 10 according to embodiments will be described with reference to the drawings.

### First Embodiment

First, the problem solver apparatus 10 according to the first embodiment will be described. The problem solver apparatus 10 calculates a solution to an integer optimization problem of minimizing an objective function including an enormous number of decision variables in a realistic time under a constraint of a linear constraint condition.

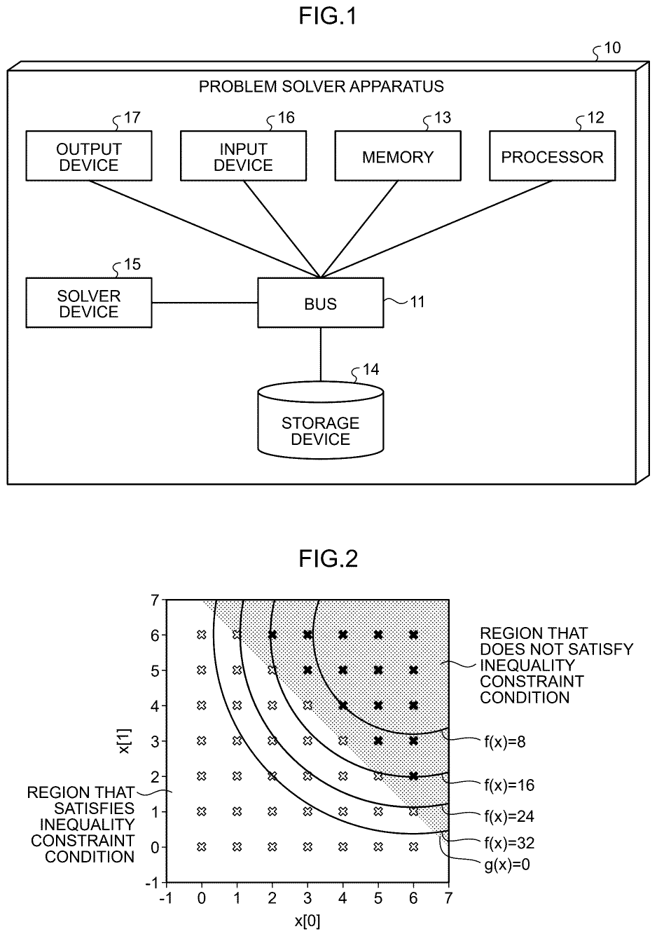

FIG. 1 is a diagram illustrating a functional configuration of the problem solver apparatus 10 according to the first embodiment.

The problem solver apparatus 10 includes a bus 11, a processor 12, a memory 13, a storage device 14, a solver device 15, an input device 16, and an output device 17. The processor 12, the memory 13, the storage device 14, the solver device 15, the input device 16, and the output device 17 are connected with each other via the bus 11.

The memory 13 and the storage device 14 store information. The processor 12 is a hardware processor such as one or more Central Processing Units (CPUs), and executes processing according to a computer program. The processor 12 functions as a processing unit of the problem solver apparatus 10. For example, the input device 16 acquires information from a user or another device. The output device 17 outputs information to the user or another device. Examples of the output device 17 include a display device.

The solver device 15 executes solving processing of finding a solution to a problem of minimizing an objective function. Note that the solver device 15 may be implemented by the processor 12 instead of being implemented by a circuit or a device separate from the processor 12.

The solver device 15 may be implemented by a CPU, a Graphics Processing Unit (GPU), or a reconfigurable semiconductor device such as a Field-Programmable Gate Array (FPGA). Furthermore, the solver device 15 may be implemented by an accelerator, an Application Specific Integrated Circuit (ASIC), or an electronic circuit including these circuits or the like. Furthermore, the solver device 15 may be implemented by an information processing device such as a computer, a computer system configured such that multiple computers or servers communicate with each other via a network, a PC cluster whose computers execute information processing in cooperation, or the like.

The solver device 15 finds an approximate solution by solving a problem of minimizing an objective function according a heuristic solution method algorithm. Consequently, the solver device 15 can output solutions that minimize the objective function.

The solver device 15 may be any device as long as the device can obtain a solution to a problem of minimizing the objective function. For example, the solver device 15 may be a device that uses a quantum annealing technology or a device that uses a pseudo quantum annealing technology.

In the present embodiment, the solver device 15 solves a problem using a simulated bifurcation algorithm. The simulated bifurcation algorithm is described in, for example, “Combinatorial optimization by simulating adiabatic bifurcations in non-linear Hamiltonian systems”, “High-performance combinatorial optimization based on classical mechanics”, JP 2021-043667 A, and JP 2021-043589 A. The simulated bifurcation algorithm will be also referred to as a quantum inspired algorithm because the simulated bifurcation algorithm has been discovered by obtaining an inspiration from a quantum mechanical optimization method based on the quantum adiabatic theorem. The simulated bifurcation algorithm can solve a combinatorial optimization problem, that is, a QUBO problem whose cost function is a quadratic function of a plurality of binary decision variables. The simulated bifurcation algorithm can also solve a combinatorial optimization problem, that is, a Higher Order Binary Optimization (HUBO) problem whose cost function is a cubic or higher-order function of a plurality of binary decision variables. The simulated bifurcation algorithm for solving the HUBO problem is described in, for example, JP 2021-043667 A. Furthermore, the simulated bifurcation algorithm can also solve a combinatorial optimization problem including a variable of a continuous value in some of or all the decision variables. The simulated bifurcation algorithm that solves the combinatorial optimization problem including the variable of the continuous value in some of or all the decision variables is described in, for example, JP 2021-043589 A.

Furthermore, in the present embodiment, the solver device 15 may include engines independently output a solution to a problem of minimizing an objective function. The solver device 15 outputs a solution for each of given problems by executing the engines in parallel. The solver device 15 may output a solution to each of the problems by one engine by repeatedly executing processing multiple times.

FIG. 2 is a diagram illustrating an example of an objective function and a penalty function in a solving target integer optimization problem according to the first embodiment.

The solving target integer optimization problem in the problem solver apparatus 10 according to the first embodiment is a problem to find a solution that minimizes an objective function under a linear constraint condition including one inequality constraint condition, and a target value constraint condition that makes the objective function equal to or more than or equal to or less than a target value.

The objective function is a quadratic objective function that is indicated by a quadratic function of decision variables. Note that the objective function may be a non-linear objective function that is indicated by a quadratic or higher-order function of the decision variables.

Each of the decision variables is an integer value decision variable. The decision variables is defined by Formula (1).

$$x [ 0 ] ∈ ℤ , x [ 1 ] ∈ ℤ , … \qquad ( 1 )$$

In Formula (1), x(0) represents a first decision variable among the decision variables. x(1) represents a second decision variable among the decision variables. Note that Z on the right-hand side represents a set of integers.

A function formula of minimizing the objective function in the integer optimization problem is defined by Formula (2).

$${minimize}_{x} f ( x ) \qquad ( 2 )$$

In Formula (2), f(x) represents an objective function. x represents a variable vector that indicates decision variables. Note that, in the present exemplary embodiment, the variable vector is a matrix of N rows and one column. N represents the number of the decision variables. x includes x(0) as a first element, x(1) as a second element, and x(N−1) as an N-th element. Hereinafter, the vector indicates a matrix with N rows and one column.

In the first embodiment, the inequality constraint condition in the integer optimization problem is defined by Formula (3).

$$g ( x ) \leq 0 \qquad ( 3 )$$

In Formula (3), g(x) represents a penalty function corresponding to the inequality constraint condition. The penalty function is defined by a linear function of a plurality of decision variables. That is, the inequality constraint condition is a constraint condition in which g(x) that is a penalty function is set to zero or less.

The target value constraint condition in the integer optimization problem is defined by Formula (4).

$$f ( x ) \leq target \qquad ( 4 )$$

In Formula (4), target represents a target value and is a real number. That is, the target value constraint condition is a condition in which f(x) as the objective function is set to be equal to or less than target that is an objective value.

When, for example, the objective function is Formula (5) and the penalty function is Formula (6), a contour of the objective function and the penalty function are illustrated in FIG. 2 in a solution space defined by the decision variables.

$$f ( x ) = {( x [ 0 ] - 6 )}^{2} + {( x [ 1 ] - 6 )}^{2} \qquad ( 5 )$$

$$g ( x ) = x [ 0 ] + x [ 1 ] - 7 \qquad ( 6 )$$

Note that points x in the drawing illustrating the solution space indicate respective positions of solutions in the solution space. The contour of the objective function is a line that connects the positions in the solution space at which the objective function values take the same value in a case where each of the decision variables is a real number value. In a case where the objective function is a convex quadratic function indicated by the two decision variables, the contour of the objective function becomes the lowest at a local minimum point, and becomes higher apart from the local minimum point.

Furthermore, a hatched region in the drawing indicating the solution space is a region that does not satisfy the inequality constraint condition, that is, a region of g(x)>0. Furthermore, an unhatched region in the drawing indicating the solution space is a region that satisfies the inequality constraint condition, that is, a region of g(x)≤0.

When, for example, solving such an integer optimization problem whose objective function is Formula (5) and whose penalty function is Formula (6), a general solver outputs, as approximate solutions, values of points x at which the objective function in the unhatched region in FIG. 2 is equal to or less than the target value. However, the local minimum point of the objective function of Formula (5) is not included in the region satisfying the inequality constraint condition (the unhatched region of the solution space), and is far from a boundary, too, at which the penalty function is zero. Accordingly, in a case where the general solver executes search processing using the objective function of Formula (5) as is, the search range becomes wide, and a very long time is taken to obtain an exact solution and a large number of approximate solutions.

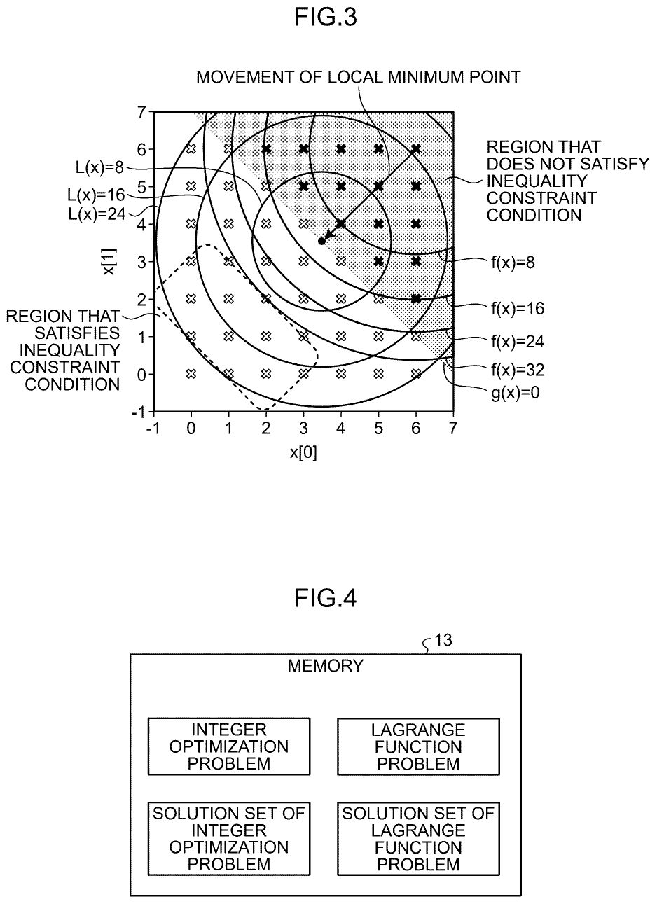

FIG. 3 is a diagram illustrating an example of a general augmented Lagrange function and a penalty function in the solving target integer optimization problem according to the first embodiment.

Furthermore, a general augmented Lagrange function (L(x)) obtained by incorporating a constraint condition in an objective function is known. The general augmented Lagrange function (L(x)) is a function obtained by moving a local minimum point to a boundary at which a penalty function becomes zero.

However, in the general augmented Lagrange function (L(x)), for example, a region in which an augmented Lagrange function value is smaller than a threshold such as a region surrounded by a broken line in FIG. 3 includes a region in which the objective function is larger than the target value, that is, a region that does not satisfy the target value constraint condition. Hence, even in a case where the problem of minimizing the general augmented Lagrange function (L(x)) is solved by the general solver, a probability of obtaining the solution from the region surrounded by the broken line in FIG. 3 becomes higher than that of the objective function, and a very long time is taken to obtain an exact solution and a large number of approximate solutions.

Next, the fast augmented Lagrange function according to the first embodiment will be described. The problem solver apparatus 10 according to the first embodiment resolves the problem caused by searching for the above-described objective function or general augmented Lagrange function by using the fast augmented Lagrange function, and calculates the solution to the integer optimization problem in a realistic time.

In the first embodiment, the fast augmented Lagrange function is defined by Formula (7).

$${L}^{′} ( x ) = f ( x ) + {λ}^{′} \cdot g ( x ) + \frac{{μ}^{′}}{2} \cdot {g ( x )}^{2} \qquad ( 7 )$$

Thus, in the first embodiment, the fast augmented Lagrange function is a function obtained by adding f(x) that is the objective function, a term obtained by multiplying λ′ on g(x) that is a penalty function, and a term obtained by multiplying (μ′/2) on g(x)² that is the square of the penalty function. Note that, in the first embodiment, λ′ will be referred to as a first parameter, and (μ′/2) will be referred to as a second parameter.

Furthermore, in the first embodiment, a function formula of minimizing the fast augmented Lagrange function is defined by Formula (8).

$${minimize}_{x} {L}^{′} ( x ) \qquad ( 8 )$$

In Formula (8), λ′ and μ′ satisfy the following first constraint to fifth constraint.

The first constraint is a constraint that L′(x) is a convex function.

The second constraint is a constraint that x_{c} is close to the local minimum point of L′(x). x_{c} is a vector that indicates a position in the solution space defined by the decision variables. x_{c} is any position on g(x)=0.

In other words, x_{c} satisfies g(x_{c})=0, ∇L′(x_{c})≈0, and ∇²L′(x_{c})>0. Such x_{c} satisfies the inequality constraint condition. A Jacobian of the fast augmented Lagrange function into which x_{c} is substituted is close to zero. A Hessian of the fast augmented Lagrange function into which x_{c} is substituted is a positive definite, that is, is larger than zero. Note that, in the present embodiment, x_{c} will be referred to as a local minimum neighboring point.

The third constraint is a constraint that a range satisfying L′(x)≤f(x) in the solution space includes the entire range satisfying the linear constraint condition in the solution space. In the first embodiment, the third constraint satisfies Formula (9).

$$\{ x \vert {L}^{′} ( x ) \leq f ( x ) \} ⊇ \{ x \vert ( f ( x ) \leq target ) ∧ ( g ( x ) \leq 0 ) \} \qquad ( 9 )$$

The fourth constraint is a constraint that L′(x) is not extremely smaller than f(x). Therefore, a difference obtained by subtracting the objective function from the fast augmented Lagrange function is equal to or larger than −ε that is a negative constant whose absolute value is sufficiently small, as defined by Formula (10).

$${L}^{′} ( x ) \geq f ( x ) - ϵ \qquad ( 10 )$$

The fifth constraint is a constraint that the range satisfying L′(x)≤f(x) in the solution space is not extremely larger than the range satisfying the linear constraint condition in the solution space. In the first embodiment, the fifth constraint satisfies Formula (11). Therefore, a ratio of the range satisfying L′(x)≤f(x) in the solution space to the range satisfying the linear constraint condition in the solution space is smaller than a magnification obtained by adding 1 to ε′ that is a positive constant whose absolute value is sufficiently small.

$$\vert \{ x \vert ( {L}^{′} ( x ) \leq f ( x ) ) \} \vert << ( 1 + {ϵ}^{′} ) \cdot \vert \{ x \vert ( f ( x ) \leq target ) ∧ ( g ( x ) \leq 0 ) \} \vert \qquad ( 11 )$$

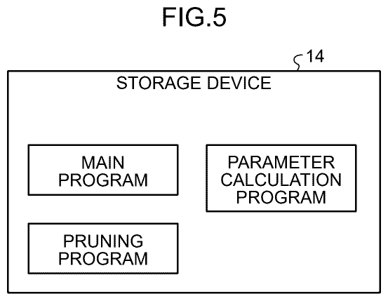

FIG. 4 is a diagram illustrating an example of information to be stored in the memory 13 according to the first embodiment.

The memory 13 stores an integer optimization problem, a Lagrange function problem, a solution set for the Lagrange function problem, and a solution set for the integer optimization problem.

The integer optimization problem is a solving target in the problem solver apparatus 10. The integer optimization problem is acquired from an external device or is input by a user via the input device 16.

The Lagrange function problem is a problem of minimizing a fast augmented Lagrange function. The fast augmented Lagrange function is generated by the processor 12 based on the integer optimization problem.

The solution set for the Lagrange function problem is obtained by solving the Lagrange function problem. The solution set for the Lagrange function problem is calculated by the solver device 15.

The solution set for the integer optimization problem is one or more solutions that are extracted from the solution set for the Lagrange function problem and satisfy the linear constraint condition. The solution set for the integer optimization problem is extracted by the processor 12 from the solution set for the Lagrange function problem. The solution set for the integer optimization problem is output to, for example, an external device or displayed on a display device as a solution to the integer optimization problem via the output device 17.

FIG. 5 is an example of information to be stored in the storage device 14 according to the first embodiment.

The storage device 14 stores a main program, a parameter calculation program, and a pruning program.

The main program is executed by the processor 12. The main program is executed by the processor 12 to cause the processor 12 to execute a series of processing from acquisition of the integer optimization problem to outputting of a solution set for the integer optimization problem.

The parameter calculation program is invoked and executed by the processor 12 during execution of the main program. The parameter calculation program is executed by the processor 12 to cause the processor 12 to calculate a parameter included in the fast augmented Lagrange function.

The pruning program is invoked and executed by the processor 12 during execution of the main program. The pruning program is executed by the processor 12 to cause the processor 12 to calculate an upper bound or a lower bound of a search range in a case of solving the Lagrange function problem of minimizing the fast augmented Lagrange function.

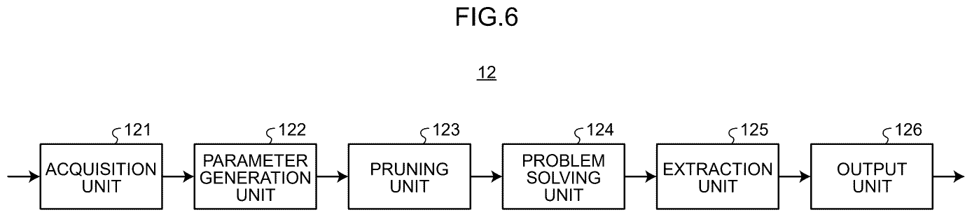

FIG. 6 is a diagram illustrating a functional configuration of the processor 12.

The processor 12 executes the main program, the parameter calculation program, and the pruning program stored in the storage device 14 to function as a processing unit including an acquisition unit 121, a parameter generation unit 122, a pruning unit 123, a problem solving unit 124, an extraction unit 125, and an output unit 126.

The acquisition unit 121 acquires an integer optimization problem of minimizing the objective function under the linear constraint condition including one inequality constraint condition and a target value constraint condition that makes objective function equal to or more than or equal to or less than a target value. The parameter generation unit 122 calculates the first parameter (λ′) and the second parameter (μ′/2) included in the fast augmented Lagrange function. The parameter generation unit 122 generates a fast augmented Lagrange function using the first parameter (λ′) and the second parameter (μ′/2). The pruning unit 123 calculates an upper bound or a lower bound of the search range in the case of solving the Lagrange function problem.

The problem solving unit 124 gives to the solver device 15 the Lagrange function problem of minimizing the fast augmented Lagrange function, and causes the solver device 15 to find one or more solutions to the Lagrange function problem of minimizing the fast augmented Lagrange function. When solving the Lagrange function problem, the problem solving unit 124 searches a region in the solution space between the local minimum neighboring point (x_{c}) of the fast augmented Lagrange function and the upper bound or the lower bound of the search range. The local minimum neighboring point (x_{c}) of the fast augmented Lagrange function will be described later in detail.

The extraction unit 125 extracts one or more solutions that satisfy the linear constraint condition, from the solution set including the one or more solutions to the Lagrange function problem. The output unit 126 outputs the solution set including the extracted one or more solutions as a solution set for the integer optimization problem.

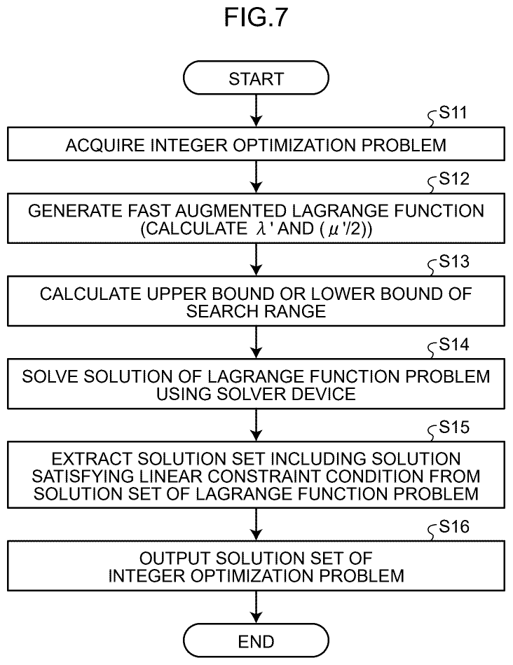

FIG. 7 is a flowchart illustrating a procedure of processing of the processor 12 according to the first embodiment. In the first embodiment, the processor 12 executes the main program stored in the storage device 14, and executes processing according to the flow illustrated in FIG. 7.

First, in S11, the processor 12 acquires an integer optimization problem of minimizing an objective function under a linear constraint condition including one inequality constraint condition and a target value constraint condition that makes the objective function equal to or more than or equal to or less than a target value.

Subsequently, in S12, the processor 12 executes the parameter calculation program stored in the storage device 14, and calculates the first parameter (λ′) and the second parameter (μ′/2) included in the fast augmented Lagrange function. Furthermore, the processor 12 generates the fast augmented Lagrange function using the first parameter (λ′) and the second parameter (μ′/2).

Subsequently, in S13, the processor 12 executes the pruning program stored in the storage device 14, and calculates the upper bound or the lower bound of the search range in the case of solving the Lagrange function problem.

Subsequently, in S14, the processor 12 gives to the solver device 15 the Lagrange function problem of minimizing the fast augmented Lagrange function, and causes the solver device 15 to find one or more solutions to the Lagrange function problem of minimizing the fast augmented Lagrange function. Furthermore, in the case of solving the Lagrange function problem, the processor 12 causes the solver device 15 to search a region in the solution space between the local minimum neighboring point (x_{c}) of the fast augmented Lagrange function and the upper bound or the lower bound of the search range.

Subsequently, in S15, the processor 12 extracts one or more solutions that satisfy the linear constraint condition from the solution set including the one or more solutions to the Lagrange function problem of minimizing the fast augmented Lagrange function.

Furthermore, in S16, the processor 12 outputs a solution set including the extracted one or more solutions as a solution set for the integer optimization problem.

The processor 12 according to the first embodiment can find the solution to the integer optimization problem of minimizing the objective function under the linear constraint condition including the one inequality constraint condition and the target value constraint condition that makes the objective function equal to or more than or equal to or less than the target value by executing the above processing in S11 to S16.

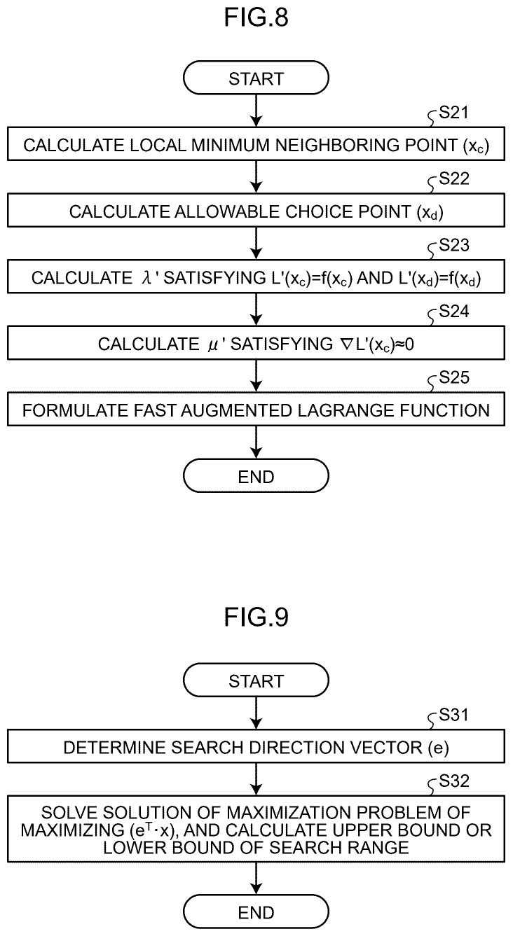

FIG. 8 is a flowchart illustrating a procedure of processing of generating the fast augmented Lagrange function in S12.

The processor 12 calculates the fast augmented Lagrange function used in the first embodiment according to the flow illustrated in FIG. 8.

First, in S21, the processor 12 calculates a local minimum neighboring point (x_{c}).

The local minimum neighboring point (x_{c}) is a vector that indicates a position in the solution space, which is defined by the decision variables included in the objective function. The local minimum neighboring point (x_{c}) includes a real number value corresponding to each of the decision variables as an element. In the first embodiment, the local minimum neighboring point (x_{c}) indicates a position at which a value is zero when the local minimum neighboring point (x_{c}) is substituted into the penalty function, and at which a value is close to a local minimum value of the objective function when the local minimum neighboring point (x_{c}) is substituted into the objective function.

Accordingly, the processor 12 solves the local minimum neighboring point calculation problem of minimizing the objective function under the constraint condition in which the penalty function is set to zero in a state where each of the decision variables is converted into a variable of a real number value. Furthermore, the processor 12 calculates the local minimum neighboring point (x_{c}) based on the solution to the local minimum neighboring point calculation problem.

In the first embodiment, the decision variables in the local minimum neighboring point calculation problem are defined by Formula (12).

$$x [ 0 ] ∈ ℝ , x [ 1 ] ∈ ℝ , … \qquad ( 12 )$$

The decision variables in the local minimum neighboring point calculation problem are generated by converting each of the decision variables in the integer optimization problem into a variable of a real number value. Note that notation of R represents a set of real number values.

Furthermore, in the first embodiment, a function formula of minimizing the objective function in the local minimum neighboring point calculation problem is defined by Formula (13).

$${minimize}_{x} f ( x ) \qquad ( 13 )$$

In the first embodiment, the constraint condition in the local minimum neighboring point calculation problem is defined by Formula (14).

$$g ( x ) = 0 \qquad ( 14 )$$

The processor 12 may cause the solver device 15 to find a solution to such a local minimum neighboring point calculation problem, and calculate the local minimum neighboring point (x_{c}) based on the solution found by the solver device 15.

Subsequently, in S22, the processor 12 calculates an allowable choice point (x_{d}).

The allowable choice point (x_{d}) is a vector that indicates a position in the solution space, which is defined by the decision variables included in the objective function. The allowable choice point (x_{d}) includes a real number value corresponding to each of the decision variables as an element. In the first embodiment, the allowable choice point (x_{d}) indicates any position that satisfies the inequality constraint condition and satisfies the target value constraint condition.

For example, the processor 12 solves the allowable choice point calculation problem of minimizing the penalty function under a condition in which the value of the objective function is equal to the target value in the state where each of the decision variables is converted into a variable of a real number value. Furthermore, the processor 12 calculates the allowable choice point (xa) based on the solution to the allowable choice point calculation problem. Note that the allowable choice point calculation problem may be a problem of minimizing the square of the penalty function under the condition in which the value of the objective function is equal to the target value.

More specifically, in the first embodiment, the decision variables in the allowable choice point calculation problem is defined by Formula (15).

$$x [ 0 ] ∈ ℝ , x [ 1 ] ∈ ℝ , … \qquad ( 15 )$$

Furthermore, in the first embodiment, a function formula of minimizing the penalty function in the allowable choice point calculation problem is defined by Formula 16.

$${minimize}_{x} g ( x ) \qquad ( 16 )$$

In the first embodiment, the constraint condition in the allowable choice point calculation problem is defined by Formula (17).

$$f ( x ) = target \qquad ( 17 )$$

Subsequently, in S23, the processor 12 calculates λ′ satisfying L′(x_{c})=f(x_{c}) and L′(x_{d})=f(x_{d}) based on the calculated local minimum neighboring point (x_{c}) and the allowable choice point (x_{d}). That is, the processor 12 calculates the first parameter satisfying the condition that the value of the fast augmented Lagrange function into which the local minimum neighboring point (x_{c}) is substituted, and the value of the objective function into which the local minimum neighboring point (x_{c}) is substituted are equal to each other, and the value of the fast augmented Lagrange function into which the allowable choice point (x_{d}) is substituted, and the value of the objective function into which the allowable choice point (x_{d}) is substituted are equal to each other.

For example, the processor 12 calculates λ′ by arithmetic processing based on Formula (18). Note that μ′ in Formula (18) is calculated by processing in next S24.

$${λ}^{′} = - \frac{{μ}^{′}}{2} \cdot ( g ( {x}_{c} ) + g ( {x}_{d} ) ) \qquad ( 18 )$$

Subsequently, in S24, the processor 12 calculates μ′ whose Jacobian of the fast augmented Lagrange function into which the local minimum neighboring point (x_{c}) is substituted is zero or is close to zero based on the calculated local minimum neighboring points (x_{c}) and λ′. That is, the processor 12 calculates the second parameter whose Jacobian of the fast augmented Lagrange function into which the local minimum neighboring point (x_{c}) is substituted is zero or is close to zero based on the calculated local minimum neighboring points (x_{c}) and λ′.

A formula whose Jacobian of the fast augmented Lagrange function into which the local minimum neighboring point (x_{c}) and λ′ calculated in S23 have been substituted is substantially zero is defined by Formula (19).

$$0 ≃ ∇ f ( {x}_{c} ) - \frac{{μ}^{′}}{2} \cdot ( g ( {x}_{c} ) + g ( {x}_{d} ) ) \cdot ∇ g ( {x}_{c} ) + {μ}^{′} \cdot g ( {x}_{c} ) \cdot ∇ g ( {x}_{c} ) = ∇ f ( {x}_{c} ) + \frac{{μ}^{′}}{2} \cdot ( g ( {x}_{c} ) + g ( {x}_{d} ) ) \cdot ∇ g ( {x}_{c} ) \qquad ( 19 )$$

On condition that μ′ is zero or more, by solving a first minimization problem that calculates μ′ that minimizes an absolute value of the right-hand side of Formula (19), the processor 12 can calculate μ′ whose Jacobian of the fast augmented Lagrange function into which the local minimum neighboring point (x_{c}) is substituted is zero or is close to zero.

In the first embodiment, the variable in the first minimization problem is defined by Formula (20).

$${μ}^{′} ∈ ℝ \qquad ( 20 )$$

Furthermore, in the first embodiment, a function formula of minimizing the absolute value of the right-hand side of Formula (19) is defined by Formula (21).

$${minimize}_{{μ}^{′}} ‖ ∇ f ( {x}_{c} ) + \frac{{μ}^{′}}{2} \cdot ( g ( {x}_{c} ) - g ( {x}_{d} ) ) \cdot ∇ g ( {x}_{c} ) ‖ \qquad ( 21 )$$

In the first embodiment, the constraint condition in the first minimization problem is defined by Formula (22).

$${μ}^{′} \geq 0 \qquad ( 22 )$$

Subsequently, in S25, the processor 12 formulates a fast augmented Lagrange function based on λ′ calculated in S23 and μ′ calculated in S24. That is, the processor 12 generates the fast augmented Lagrange function obtained by adding the objective function, the term obtained by multiplying the first parameter (λ′) on the penalty function, and a term obtained by multiplying the second parameter (μ′/2) on the square of the penalty function.

More specifically, the processor 12 generates the fast augmented Lagrange function defined by Formula (23).

$${L}^{′} ( x ) = f ( x ) + {λ}^{′} \cdot g ( x ) + \frac{{μ}^{′}}{2} \cdot {g ( x )}^{2} \qquad ( 23 )$$

FIG. 9 is a flowchart illustrating a procedure of the pruning processing in S13.

The processor 12 calculates an upper bound or a lower bound of the search range in the case of solving the Lagrange function problem of minimizing the fast augmented Lagrange function according to the flow illustrated in FIG. 9.

First, in S31, the processor 12 determines a search direction vector (e). The search direction vector (e) includes an element corresponding to each of the decision variables. Each of the elements included in the search direction vector (e) indicates a search direction of the corresponding decision variable.

For example, the search direction vector (e) indicates a direction from the local minimum neighboring point (x_{c}) to the allowable choice point (x_{d}) as a search direction for each of the decision variables. For example, each of the elements included in the search direction vector (e) is +1 in a case where the search direction is a positive direction, and is −1 in a case where the search direction is a negative direction.

Note that the search direction vector (e) may indicate a search direction for each of one or more decision variables that limit the search range among the decision variables. In this case, the search direction vector (e) may include a predetermined value (e.g., zero) indicating that the search direction is not limited as an element corresponding to the decision variable that does not limit the search range.

Subsequently, in S32, the processor 12 solves a maximization problem of maximizing (e^{T}·x) under the constraint condition in which the value of the fast augmented Lagrange function is equal to or larger than the target value in the state where each of the decision variables is converted into the variable of the real number value. Furthermore, the processor 12 determines the upper bound or the lower bound of the search range in the case of solving the problem of minimizing the fast augmented Lagrange function based on the solution to the maximization problem.

More specifically, the decision variables in the maximization problem are defined by Formula (24).

$$x [ 0 ] ∈ ℝ , x [ 1 ] ∈ ℝ , … \qquad ( 24 )$$

Furthermore, a function formula of maximizing (e^{T}·x) in the maximization problem is defined by Formula (25).

$${maximize}_{x} {e}^{T} \cdot x \qquad ( 25 )$$

Note that e^{T} represents a transposed matrix of the search direction vector (e).

The constraint condition in the maximization problem is defined by Formula (26).

$${L}^{′} ( x ) \leq target \qquad ( 26 )$$

The processor 12 solves the above-described maximization problem to calculate the upper bound or the lower bound of the search range.

Here, in a case where the fast augmented Lagrange function is a convex quadratic function, the fast augmented Lagrange function can be defined in the form of completing the square as in Formula (27).

$${L}^{′} ( x ) = \frac{1}{2} {( x - {x}_{0} )}^{T} \cdot {Q}_{0} \cdot ( x - {x}_{0} ) + {c}_{0} \qquad ( 27 )$$

Q₀ represents a semi-positive definite matrix whose numbers of rows and columns are equal to the number of the decision variables. Each of the elements included in Q₀ is a real number value.

x₀ represents a vector that includes elements whose number is equal to the number of the decision variables. Each of the elements included in x₀ is a real number value.

c₀ represents a scalar and a real number value.

Here, x that maximizes (e^{T}·x) is represented as xₘₐₓ. xₘₐₓ represents a vector including elements whose number is equal to the number of the decision variables.

Furthermore, an inclination of the penalty function at xₘₐₓ that maximizes (e^{T}·x) and a direction of the search direction vector (e) are parallel at all times. The magnitude of the inclination of the penalty function at xₘₐₓ that maximizes (e^{T}·x) is represented by α. In this case, xₘₐₓ is defined by Formula (28).

$${Q}_{0} \cdot ( {x}_{max} - {x}_{0} ) = α \cdot e ∴ {x}_{max} - {x}_{0} + α \cdot {( {Q}_{0} )}^{- 1} \cdot e \qquad ( 28 )$$

Furthermore, since xₘₐₓ maximizes (e^{T}·x), the value of the fast augmented Lagrange function obtained by converting each of the decision variables into a variable of a real number value is the target value at all times. Accordingly, α is defined by Formula (29).

$$\frac{1}{2} {( {x}_{max} - {x}_{0} )}^{T} \cdot {Q}_{0} \cdot ( {x}_{max} - {x}_{0} ) + {c}_{0} = target \qquad ( 29 )$$

$$\frac{{α}^{2}}{2} {( {( {Q}_{0} )}^{- 1} \cdot e )}^{T} \cdot {Q}_{0} \cdot ( {( {Q}_{0} )}^{- 1} \cdot e ) = target - {c}_{0}$$

$$\frac{{α}^{2}}{2} {e}^{T} \cdot {( {Q}_{0} )}^{- 1} \cdot e = target - {c}_{0}$$

$$∴ α = \sqrt{\frac{2 \cdot ( target - {c}_{0} )}{{e}^{T} \cdot {( {Q}_{0} )}^{- 1} \cdot e}}$$

In view of the above, in the case where the fast augmented Lagrange function is the convex quadratic function, the processor 12 can calculate the solution to the maximization problem of maximizing (e^{T}·x) under the constraint condition that the value of the fast augmented Lagrange function obtained by converting each of the decision variables into the variable of the real number value is equal to or larger than the target value according to Formula (30).

$$max [ {e}^{T} \cdot x ] = {e}^{T} \cdot {x}_{0} + \sqrt{2 \cdot ( target - {c}_{0} )} \cdot \sqrt{{e}^{T} \cdot {( {Q}_{0} )}^{- 1} \cdot e} \qquad ( 30 )$$

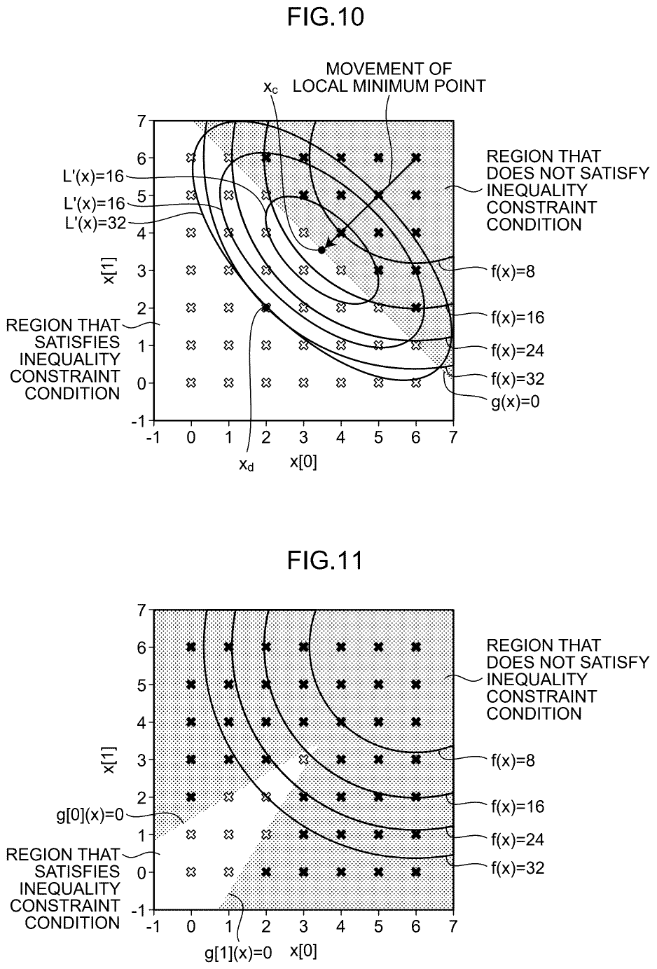

FIG. 10 is a diagram illustrating an example of a solution space that indicates a Lagrange function problem according to the first embodiment.

For example, it is assumed that the objective function is Formula (31), the penalty function is Formula (32), and the target value is Formula (33).

$$f ( x ) = {( x [ 0 ] - 6 )}^{2} + {( x [ 1 ] - 6 )}^{2} \qquad ( 31 )$$

$$g ( x ) = x [ 0 ] + x [ 1 ] - 7 \qquad ( 32 )$$

$$target = 32 \qquad ( 33 )$$

In this case, by executing the processing of FIG. 8, the processor 12 calculates a vector of Formula (34) as the local minimum neighboring point (x_{c}), a vector of Formula (35) as the allowable choice point (x_{d}), a value of Formula (36) as λ′, and a value of Formula (37) as μ′.

$${x}_{c} = ( 3.5 , 3.5 ) \qquad ( 34 )$$

$${x}_{d} = ( 2. , 2. ) \qquad ( 35 )$$

$${λ}^{′} = 5. \qquad ( 36 )$$

$${μ}^{′} = 3.333 \qquad ( 37 )$$

Furthermore, a contour of the objective function (f(x)), a contour of the fast augmented Lagrange function (L′(x)), and the penalty function are illustrated in FIG. 10 in the solution space. As illustrated in FIG. 10, in the fast augmented Lagrange function (L′(x)) according to the first embodiment, the local minimum neighboring point (x_{c}) is close to the boundary at which the inequality constraint condition (g(x)≤0) is satisfied or is not satisfied in the region satisfying the constraint condition (the unhatched region of the solution space). Consequently, in a case where the solver device 15 executes the search processing using the fast augmented Lagrange function (L′(x)), it is possible to narrow the search range, and reduce a time required to obtain the exact solution and a large number of approximate solutions.

Furthermore, the region in which the fast augmented Lagrange function (L′(x)) is the target value (L′(x)=32) or less according to the first embodiment is regions in which the objective function (f(x)) is the target value (f(x)=32) or less and includes all the regions satisfying the constraint conditions (the unhatched regions in the solution space). Accordingly, by executing the search processing within the range of the upper bound or the lower bound of the search range, the solver device 15 does not need to search a range in which the objective function (f(x)) is larger than the target value, and it is possible to reduce the time required to obtain the exact solution and the large number of approximate solutions.

As described above, the problem solver apparatus 10 according to the first embodiment can improve a probability of obtaining the exact solution or the large number of approximate solutions and reduce the time required for solving.

### Second Embodiment

Next, a problem solver apparatus 10 according to the second embodiment will be described. Since the problem solver apparatus 10 according to the second embodiment has substantially the same configuration and functions as those of the first embodiment, components having substantially the same configuration and functions will be assigned the same reference numerals, and detailed description thereof will be omitted except for differences.

FIG. 11 is a diagram illustrating an example of a solution space that indicates a solving target integer optimization problem in the problem solver apparatus 10 according to the second embodiment.

The solving target integer optimization problem in the problem solver apparatus 10 according to the second embodiment is a problem to find a solution that minimizes an objective function under a linear constraint condition including one or more inequality constraint conditions and a target value constraint condition that makes the objective function equal to or more than or equal to or less than a target value indicated as a real number.

In the second embodiment, a plurality of decision variables, the problem of minimizing the objective function, and the target value constraint condition are indicated in the same manner as in the first embodiment. However, in the second embodiment, the linear constraint condition includes I inequality constraint conditions (I represents an integer equal to or more than one). I represents the number of one or more inequality constraint conditions.

An i-th inequality constraint condition among the I inequality constraint conditions is defined by Formula (38).

$$g [ i ] ( x ) \leq 0 \qquad ( 38 )$$

i represents an integer equal to or more than zero and equal to or less than (I−1), and is an index that indicates an (i+1)-th inequality constraint condition among the I inequality constraint conditions.

Furthermore, in the second embodiment, the linear constraint condition is defined by Formula (39).

$$( g [ 0 ] ( x ) \leq 0 ) ∧ ( g [ 1 ] ( x ) \leq 0 ∧ … ∧ ( g [ I - 1 ] ( x ) \leq 0 ) ) \qquad ( 39 )$$

g(0)(x) represents a penalty function of a first inequality constraint condition among the I inequality constraints. g(1)(x) represents a penalty function of a second inequality constraint condition among the I inequality constraints. g(I−1)(x) represents a penalty function of an I-th inequality constraint condition among the I inequality constraints. Each of the one or more penalty functions is indicated by a linear function of the decision variables. Note that A represents a logical conjunction.

If, for example, the integer optimization problem includes two inequality constraint conditions, the objective function is Formula (40), the penalty function of the first inequality constraint condition is Formula (41), and the penalty function of the second inequality constraint condition is Formula (42), the contour of the objective function and the two penalty functions are illustrated in FIG. 11 in the solution space.

$$f ( x ) = {( x [ 0 ] - 6 )}^{2} + {( x [ 1 ] - 6 )}^{2} \qquad ( 40 )$$

$$g [ 0 ] ( x ) = - 0.6 * x [ 0 ] + x [ 1 ] - 1.4 \qquad ( 41 )$$

$$g [ 1 ] ( x ) = + x [ 0 ] - 0.6 * x [ 1 ] - 1.4 \qquad ( 42 )$$

In a case where, for example, such an integer optimization problem in which the objective function is Formula (40) and the two penalty functions are Formula (41) and Formula (42) is solved, a general solver outputs, as an approximate solution, a value of a point x at which the objective function in an unhatched region in FIG. 11 is equal to or less than the target value. However, a local minimum point of the objective function of Formula (40) is not included in the region satisfying the inequality constraint condition (the unhatched region in the solution space), and is far from a boundary, too, at which the penalty function is zero. Accordingly, in a case where the general solver executes the search processing using the objective function of Formula (40) as is, a search range becomes wide, and a very long time is taken to obtain an exact solution and a large number of approximate solutions.

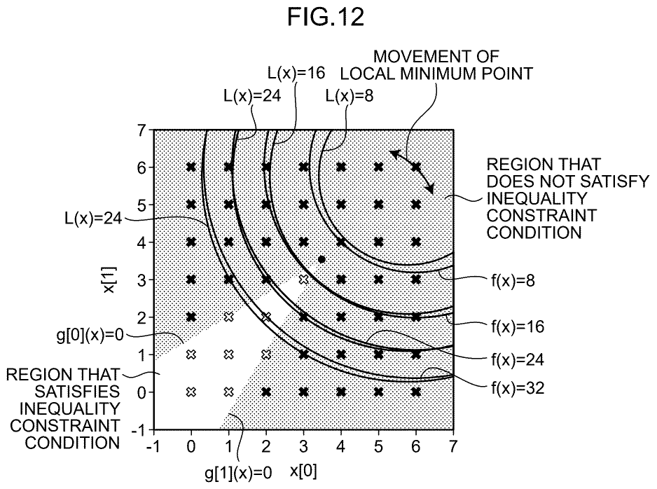

FIG. 12 is a diagram illustrating an example of a general augmented Lagrange function and a penalty function in a solving target integer optimization problem according to the second embodiment.

Furthermore, a general augmented Lagrange function (L(x)) is known. It is also conceivable to improve accuracy of the augmented Lagrange function (L(x)) by repeatedly updating λ and μ and moving the local minimum point to the boundary at which the penalty function becomes zero. However, even if the general augmented Lagrange function (L(x)) is repeatedly updated, adjustment of λ and μ interferes and the local minimum point vibrates in a case where the penalty functions are as in Formula (41) and Formula (42), and therefore a time taken until the local minimum point moves to a range satisfying both of the two inequality constraint conditions becomes exponentially long.

Next, the fast augmented Lagrange function used in the second embodiment will be described. By using the fast augmented Lagrange function, the problem solver apparatus 10 according to the second embodiment solves the problem caused by searching for the above-described objective function and repeatedly updating the general augmented Lagrange function, and calculates the solution to the integer optimization problem in a realistic time.

In the second embodiment, the fast augmented Lagrange function is defined by Formula (43).

$${L}^{′} ( x ) = f ( x ) + {\sum }_{i ∈ \{ 0 , … , I - 1 \}} ( {λ}^{′} [ i ] \cdot g [ i ] ( x ) + \frac{{μ}^{′} [ i ]}{2} \cdot g [ i ] {( x )}^{2} ) \qquad ( 43 )$$

That is, in the second embodiment, the fast augmented Lagrange function is a function obtained by adding f(x) that is the objective function, one or more terms obtained by multiplying corresponding λ′(i) on g(i)(x) that is each of one or more penalty functions, and one or more terms obtained by multiplying corresponding (μ′(i)/2) on g(i)(x)² that is the square of each of one or more penalty functions. Note that, in the second embodiment, λ′(i) will be referred to as a first parameter, and (μ′(i)/2) will be referred to as a second parameter.

λ′(i) and μ′(i) satisfy a first constraint to a fifth constraint similarly to the first embodiment.

Note that, in the second embodiment, the third constraint satisfies Formula (44).

$$( 44 )$$

$$\{ x \vert ( {L}^{′} ( x ) \leq f ( x ) ) \} ⊇ \{ x \vert ( f ( x ) \leq target ) ∧ ( g [ 0 ] ( x ) \leq 0 ) ∧ ( g [ 1 ] ( x ) \leq 0 ) ∧ … ∧ ( g [ I - 1 ] ( x ) \leq 0 ) \}$$

Furthermore, in the second embodiment, the fifth constraint satisfies Formula (45).

$$( 45 )$$

$$\vert \{ x \vert ( {L}^{′} ( x ) \leq f ( x ) ) \} \vert << ( 1 + {ϵ}^{′} ) \cdot \vert \{ x \vert ( f ( x ) \leq target ) ∧ ( g [ 0 ] ( x ) \leq 0 ) ∧ ( g [ 1 ] ( x ) \leq 0 ) ∧ … ∧ ( g [ I - 1 ] ( x ) \leq 0 ) \} \vert$$

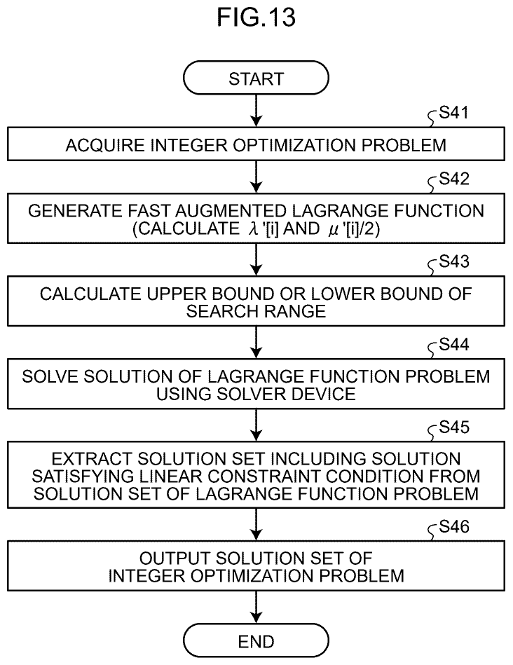

FIG. 13 is a flowchart illustrating a procedure of processing of a processor 12 according to the second embodiment. In the second embodiment, the processor 12 executes a main program stored in a storage device 14, and executes processing according to the flow illustrated in FIG. 13.

First, in S41, the processor 12 acquires an integer optimization problem of minimizing the objective function under the linear constraint condition including the one or more inequality constraint conditions and the target value constraint condition that makes the objective function equal to or more than or equal to or less than the target value.

Subsequently, in S42, the processor 12 executes a parameter calculation program stored in the storage device 14 to generate a fast augmented Lagrange function. More specifically, for each of the one or more penalty functions corresponding to the one or more inequality constraint conditions, the processor 12 calculates a first parameter (λ′(i)) to be multiplied on the target penalty function (g(i)(x)) and a second parameter (μ′(i)/2) to be multiplied on a square (g(i)(x)²) of the target penalty function. Furthermore, the processor 12 generates the fast augmented Lagrange function by using the first parameter (λ′(i)) and the second parameter (μ′(i)/2).

Subsequently, in S43, the processor 12 executes a pruning program stored in the storage device 14 to calculate an upper bound or a lower bound of a search range in a case of solving the Lagrange function problem of minimizing the fast augmented Lagrange function. Note that the processor 12 calculates the upper bound or the lower bound of the search range in the case of solving the Lagrange function problem of minimizing the fast augmented Lagrange function by processing similar to that of the first embodiment.

Subsequently, in S44, the processor 12 gives to the solver device 15 the Lagrange function problem of minimizing the fast augmented Lagrange function, and causes the solver device 15 to find one or more solutions to the Lagrange function problem of minimizing the fast augmented Lagrange function. Furthermore, in the case of solving the Lagrange function problem, the processor 12 causes the solver device 15 to search a region in the solution space between a local minimum neighboring point (x_{c}) of the fast augmented Lagrange function and the upper bound or the lower bound of the search range.

Subsequently, in S45, the processor 12 extracts one or more solutions that satisfy the linear constraint condition as the one or more solutions of the integer optimization problem from a solution set including the one or more solutions to the Lagrange function problem of minimizing the fast augmented Lagrange function.

Furthermore, in S46, the processor 12 outputs the solution set including the extracted one or more solutions as a solution set for the integer optimization problem.

By executing the above processing in S41 to S46, the processor 12 according to the second embodiment can find the solution to the integer optimization problem of minimizing the objective function under the linear constraint condition including the one or more inequality constraint conditions and the target value constraint condition that makes the objective function equal to or more than or equal to or less than the target value.

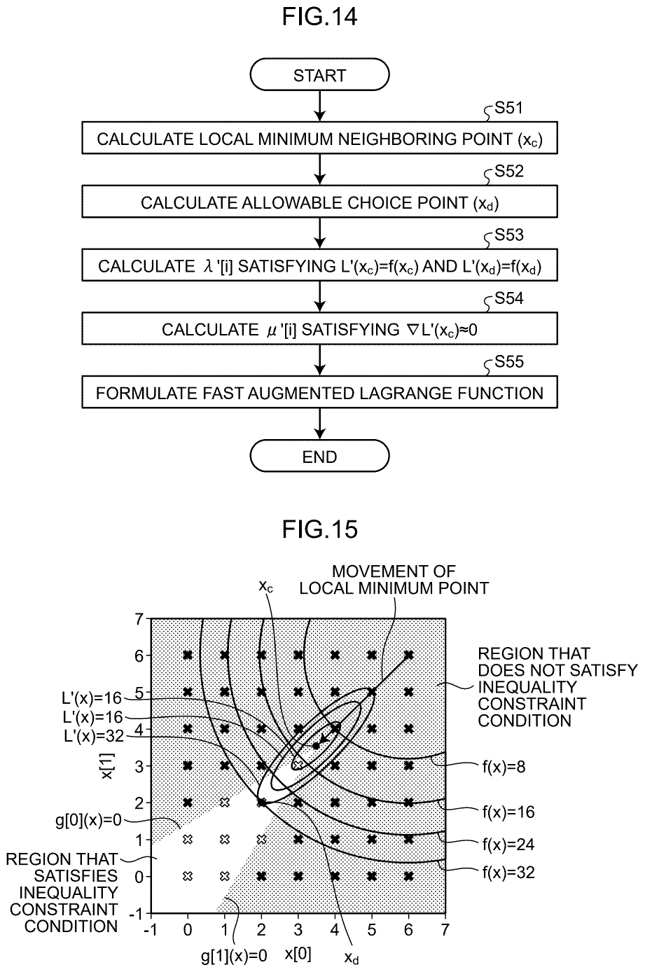

FIG. 14 is a flowchart illustrating a procedure of processing of generating the fast augmented Lagrange function in S42.

The processor 12 calculates the fast augmented Lagrange function used in the second embodiment according to the flow illustrated in FIG. 14.

First, in S51, the processor 12 calculates the local minimum neighboring point (x_{c}).

In the second embodiment, the local minimum neighboring point (x_{c}) indicates a position at which a value is zero when the local minimum neighboring point (x_{c}) is substituted into each of the one or more penalty functions, and at which a value is close to the local minimum value of the objective function when the local minimum neighboring point (x_{c}) is substituted into the objective function. Accordingly, the processor 12 solves a local minimum neighboring point calculation problem of minimizing the objective function under the constraint condition in which the one or each of the penalty functions is set to zero in a state where each of the decision variables is converted into a variable of a real number value. Furthermore, the processor 12 calculates the local minimum neighboring point (x_{c}) based on the solution to the local minimum neighboring point calculation problem.

More specifically, in the second embodiment, the decision variables in the local minimum neighboring point calculation problem are defined by Formula (46).

$$x [ 0 ] ∈ ℝ , x [ 1 ] ∈ ℝ , … \qquad ( 46 )$$

Furthermore, in the second embodiment, a function formula of minimizing the objective function in the local minimum neighboring point calculation problem is defined by Formula (47).

$${minimize}_{x} f ( x ) \qquad ( 47 )$$

In the second embodiment, the constraint condition in the local minimum neighboring point calculation problem is defined by Formula (48).

$$( g [ 0 ] ( x ) \leq 0 ) ∧ ( g [ 1 ] ( x ) = 0 ∧ … ∧ ( g [ I - 1 ] ( x ) = 0 ) ) \qquad ( 48 )$$

The processor 12 may cause the solver device 15 to find a solution to such a local minimum neighboring point calculation problem, and may calculate the local minimum neighboring point (x_{c}) based on the solution obtained from the solver device 15.

Subsequently, in S52, the processor 12 calculates an allowable choice point (x_{d}).

In the second embodiment, the allowable choice point (x_{d}) is a point that satisfies all of the one or more inequality constraint conditions and satisfies the target value constraint condition. Accordingly, the processor 12 solves the allowable choice point calculation problem of minimizing the function obtained by adding a square of each of the one or more penalty functions under a condition in which the value of the objective function is equal to the target value in the state where each of the decision variables is converted into the variable of the real number value. Furthermore, the processor 12 calculates the allowable choice point (x_{d}) based on the solution to the allowable choice point calculation problem.

More specifically, in the second embodiment, the decision variables in the allowable choice point calculation problem is defined by Formula (49).

$$x [ 0 ] ∈ ℝ , x [ 1 ] ∈ ℝ , … \qquad ( 49 )$$

Furthermore, in the second embodiment, a function formula of minimizing a function obtained by adding the square of each of the one or more penalty functions is defined by Formula (50).

$${minimize}_{x} g [ 0 ] {( x )}^{2} + ( g [ 1 ] {( x )}^{2} + … + g [ I - 1 ] {( x )}^{2} \qquad ( 50 )$$

In the second embodiment, the constraint condition in the allowable choice point calculation problem is defined by Formula (51).

$$f ( x ) = target \qquad ( 51 )$$

The processor 12 may cause the solver device 15 to find a solution to such an allowable choice point calculation problem and may calculate the allowable choice point (x_{d}) based on the solution obtained from the solver device 15.

Subsequently, in S53, the processor 12 calculates λ′(i) that satisfies L′(x_{c})=f(x_{c}) and L′(x_{d})=f(x_{d}) based on the calculated local minimum neighboring point (x_{c}) and allowable choice point (x_{d}). That is, the processor 12 calculates the first parameter that satisfies the condition that the value of the fast augmented Lagrange function into which the local minimum neighboring point (x_{c}) is substituted, and the value of the objective function into which the local minimum neighboring point (x_{c}) is substituted are equal to each other, and the value of the fast augmented Lagrange function into which the allowable choice point (x_{d}) is substituted, and the value of the objective function into which the allowable choice point (x_{d}) is substituted are equal to each other.

For example, the processor 12 can calculate λ′(i) for each of the one or more inequality constraint conditions by arithmetic processing based on Formula (52). Note that μ′(i) in Formula (52) is calculated by processing in S54.

$${λ}^{′} [ i ] = - \frac{{μ}^{′} [ i ]}{2} \cdot ( g [ i ] ( {x}_{c} ) + g [ i ] ( {x}_{d} ) ) \qquad ( 52 )$$

Subsequently, in S54, the processor 12 calculates μ′(i) whose Jacobian of the fast augmented Lagrange function into which the local minimum neighboring point (x_{c}) is substituted is zero or is close to zero based on the calculated local minimum neighboring points (x_{c}) and λ′(i). That is, the processor 12 calculates the second parameter whose Jacobian of the fast augmented Lagrange function into which the local minimum neighboring point (x_{c}) is substituted is zero or is close to zero based on the calculated local minimum neighboring point (x_{c}) and λ′(i).

The formula whose Jacobian of the fast augmented Lagrange function into which the local minimum neighboring point (x_{c}) and λ′(i) calculated in S53 have been substituted is substantially zero is defined by Formula (53).

$$0 ≃ ∇ f ( {x}_{c} ) + {\sum }_{i ∈ \{ 0 , … , ( I - 1 ) \}} ( + \frac{{μ}^{′} [ i ]}{2} \cdot ( g [ i ] ( {x}_{c} ) - g [ i ] ( {x}_{d} ) ) \cdot ∇ g [ i ] ( {x}_{c} ) ) \qquad ( 53 )$$

Accordingly, the processor 12 calculates μ′(i) whose Jacobian of the fast augmented Lagrange function into which the local minimum neighboring point (x_{c}) is substituted is zero or is close to zero, based on the solution to the first minimization problem of minimizing the absolute value of the right-hand side of Formula (53) in which μ′(i) is a variable on a condition in which μ′(i) is zero or more.

In the second embodiment, the variable in the first minimization problem is defined by Formula (54).

$${μ}^{′} [ 0 ] ∈ ℝ , {μ}^{′} [ 1 ] ∈ ℝ , … \qquad ( 54 )$$

Furthermore, in the second embodiment, a function formula of minimizing the absolute value of the right-hand side of Formula (54) is defined by Formula (55).

$${minimize}_{{μ}^{′}} ‖ ∇ f ( {x}_{c} ) + {\sum }_{i ∈ \{ 0 , … , I - 1 \}} ( \frac{{μ}^{′} [ i ]}{2} \cdot ( g [ i ] ( {x}_{c} ) - g [ i ] ( {x}_{d} ) ) \cdot ∇ g [ i ] ( {x}_{c} ) ) ‖ \qquad ( 55 )$$

In the second embodiment, the constraint condition in the first minimization problem is defined by Formula (56).

$${μ}^{′} [ 0 ] \geq 0 , {μ}^{′} [ 1 ] \geq 0 , … , {μ}^{′} [ I - 1 ] \qquad ( 56 )$$

Subsequently, in S55, the processor 12 formulates the fast augmented Lagrange function based on λ′(i) calculated in S53 and μ′(i) calculated in S54. That is, the processor 12 generates the fast augmented Lagrange function obtained by adding the objective function, one or more terms obtained by multiplying the corresponding first parameter on each of the one or more penalty functions, and one or more terms obtained by multiplying the corresponding second parameter on a square of each of the one or more penalty functions.

More specifically, the processor 12 generates the fast augmented Lagrange function defined by Formula (57).

$${L}^{′} ( x ) = f ( x ) + {\sum }_{i ∈ \{ 0 , … , I - 1 \}} ( {λ}^{′} [ i ] \cdot g [ i ] ( x ) + \frac{{μ}^{′} [ i ]}{2} \cdot g [ i ] {( x )}^{2} ) \qquad ( 57 )$$

FIG. 15 is a diagram illustrating an example of a solution space that indicates the Lagrange function problem according to the second embodiment.

For example, it is assumed that the objective function is Formula (58), a first penalty function is Formula (59), a second penalty function is Formula (60), and the target value is Formula (61).

$$f ( x ) = {( x [ 0 ] - 6 )}^{2} + {( x [ 1 ] - 6 )}^{2} \qquad ( 58 )$$

$$g [ 0 ] ( x ) = 0.6 * x [ 0 ] + x [ 1 ] - 5.6 \qquad ( 59 )$$

$$g [ 1 ] ( x ) = x [ 0 ] + 0.6 * x [ 1 ] - 5.6 \qquad ( 60 )$$

$$target = 32 \qquad ( 61 )$$

In this case, the processor 12 executes processing in FIG. 14 to calculate a vector of Formula (62) as the local minimum neighboring point (x_{c}), a vector of Formula (63) as the allowable choice point (x_{d}), a value of Formula (64) as μ′(0), a value of Formula (65) as μ′(1), a value of Formula (66) as λ′(0), and a value of Formula (67) as λ′(1).

$${x}_{c} = ( 3.5 , 3.5 ) \qquad ( 62 )$$

$${x}_{d} = ( 2. , 2. ) \qquad ( 63 )$$

$${μ}^{′} [ 0 ] = 41.666 \qquad ( 64 )$$

$${μ}^{′} [ 1 ] = 41.666 \qquad ( 65 )$$

$${λ}^{′} [ 0 ] = 12.5 \qquad ( 66 )$$

$${λ}^{′} [ 1 ] = 12.5 \qquad ( 67 )$$

Furthermore, a contour of the objective function (f(x)), a contour of the fast augmented Lagrange function (L′(x)), the first penalty function, and the second penalty function are as illustrated in FIG. 15 in the solution space. As illustrated in FIG. 15, in the fast augmented Lagrange function (L′(x)) according to the second embodiment, the local minimum neighboring point (x_{c}) is close to the boundary at which each of the one or more inequality constraint conditions (g(i)(x)≤0) is satisfied or is not satisfied in a region satisfying the constraint condition (an unhatched region in the solution space). Consequently, in a case where the solver device 15 executes the search processing using the fast augmented Lagrange function (L′(x)), it is possible to narrow the search range, and reduce a time required to obtain the exact solution and a large number of approximate solutions.

Furthermore, the regions in which the fast augmented Lagrange function (L′(x)) according to the second embodiment is the target value (L′(x)=32) or less are regions in which the objective function (f(x)) is the target value (f(x)=32) or less and include all the regions satisfying the constraint conditions (the unhatched regions in the solution space). Accordingly, by executing the search processing within the range of the upper bound or the lower bound of the search range, the solver device 15 does not need to search a range in which the objective function (f(x)) is larger than the target value, and it is possible to reduce the time required to obtain the exact solution and the large number of approximate solutions.

Furthermore, the problem solver apparatus 10 according to the second embodiment can calculate λ′(i) and μ′(i) that are parameters of the fast augmented Lagrange function (L′(x)) only by performing calculation processing once without repeatedly calculating λ′(i) and μ′(i) multiple times. Consequently, the problem solver apparatus 10 according to the second embodiment can reduce the time required to obtain the exact solution and the large number of approximate solutions.

As described above, the problem solver apparatus 10 according to the second embodiment can improve a probability of obtaining the exact solution or the large number of approximate solutions and reduce the time required for solving.

### Third Embodiment

Next, a problem solver apparatus 10 according to the third embodiment will be described. Since the problem solver apparatus 10 according to the third embodiment has substantially the same configuration and functions as those of the second embodiment, components having substantially the same configuration and functions will be assigned the same reference numerals, and detailed description thereof will be omitted except for differences.

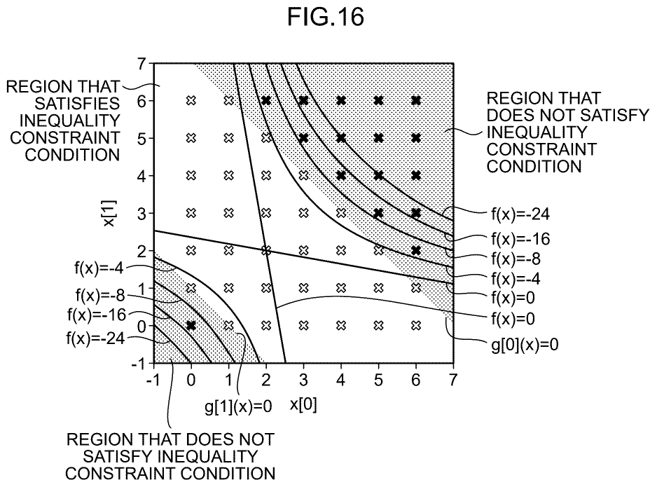

FIG. 16 is a diagram illustrating an example of a solution space that indicates a solving target integer optimization problem in the problem solver apparatus 10 according to the third embodiment.

The solving target integer optimization problem in the problem solver apparatus 10 according to the third embodiment is a problem to find a solution that minimizes an objective function under a linear constraint condition including a plurality of inequality constraint conditions and a target value constraint condition that makes the objective function equal to or more than or equal to or less than a target value indicated as a real number.

In the third embodiment, a plurality of decision variables, a problem of minimizing an objective function, the plurality of inequality constraint conditions, and the target value constraint condition are indicated in the same manner as in the second embodiment. In this regard, in the third embodiment, the objective function may be a non-convex quadratic function.

For example, if the integer optimization problem includes two inequality constraint conditions, the objective function is Formula (68), the penalty function of the first inequality constraint is Formula (69), and the penalty function of the second inequality constraint is Formula (70), the contour of the objective function and the two penalty functions are illustrated in FIG. 16 in the solution space.

$$f ( x ) = - {( x [ 0 ] + x [ 1 ] - 4 )}^{2} + 0.5 \cdot {( x [ 0 ] - x [ 1 ] )}^{2} \qquad ( 68 )$$

$$g [ 0 ] ( x ) = x [ 0 ] + x [ 1 ] - 7 \qquad ( 69 )$$

$$g [ 1 ] ( x ) = - x [ 0 ] - x [ 1 ] + 1 \qquad ( 70 )$$

In a case where, for example, such an integer optimization problem in which the objective function is Formula (68) and the two penalty functions are Formula (69) and Formula (70) is solved, a general solver outputs, as an approximate solution, a value of a point x at which the objective function in an unhatched region in FIG. 16 is equal to or less than the target value. However, a local minimum point of the objective function of Formula (68) is not included in the region satisfying the inequality constraint condition (the unhatched region of the solution space), and is far from a boundary, too, at which the penalty function is zero. Accordingly, when the general solver executes the search processing using the objective function of Formula (68) as is, the search range becomes wide, and a very long time is taken to obtain an exact solution and a large number of approximate solutions.

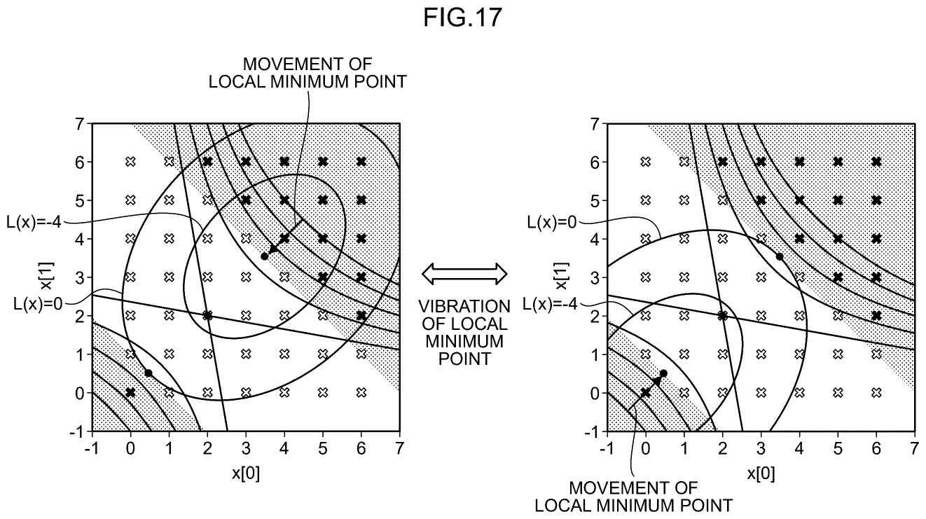

FIG. 17 is a diagram illustrating an example of a general augmented Lagrange function and a penalty function in the solving target integer optimization problem according to the third embodiment.

Furthermore, the objective function (f(x)) includes two local minimum points. Furthermore, the two local minimum points included in the objective function (f(x)) are dispersed in regions that exist with the region that satisfies the constraint condition and is interposed therebetween, and do not satisfy the two different constraint conditions. Accordingly, even if the general augmented Lagrange function (L(x)) is repeatedly updated, adjustment of λ and μ interferes between the two constraint conditions, the local minimum point greatly vibrates, and therefore, a very long time is taken to obtain the exact solution and a large number of approximate solutions.

By using the fast augmented Lagrange function, the problem solver apparatus 10 according to the third embodiment solves the problem caused by searching for the above-described objective function and repeatedly updating the general augmented Lagrange function, and calculates the solution to the integer optimization problem in a realistic time.

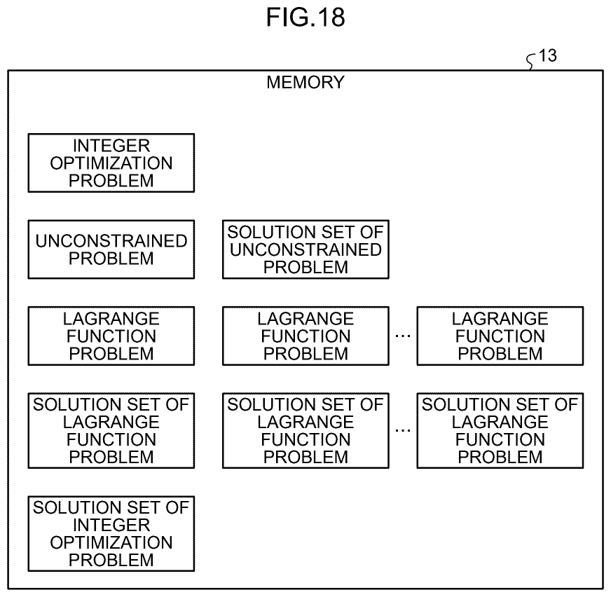

FIG. 18 is a diagram illustrating an example of information to be stored in a memory 13 according to the third embodiment.

The memory 13 according to the third embodiment stores an integer optimization problem, an unconstrained problem, a solution set for the unconstrained problem, a plurality of Lagrange function problems, a solution set for the plurality of Lagrange function problems, and a solution set for the integer optimization problem.

The unconstrained problem is a problem obtained by removing a linear constraint condition of the integer optimization problem. That is, the unconstrained problem is a problem of minimizing the objective function included in the integer optimization problem without a constraint condition.

The solution set for the unconstrained problem is obtained by solving the unconstrained problem. The solution set for the unconstrained problem is calculated by a solver device 15.

Each of the Lagrange function problems is a problem of minimizing the fast augmented Lagrange function. In this regard, each of the Lagrange function problems has respectively different parameters of functions of the fast augmented Lagrange function.

The solution set for the Lagrange function problems is corresponding to each of the Lagrange function problems on a one-to-one basis. Each of the solution sets for the Lagrange function problems is obtained by solving a corresponding Lagrange function problem among the Lagrange function problems. Each of the solution sets for the Lagrange function problems is calculated by the solver device 15.

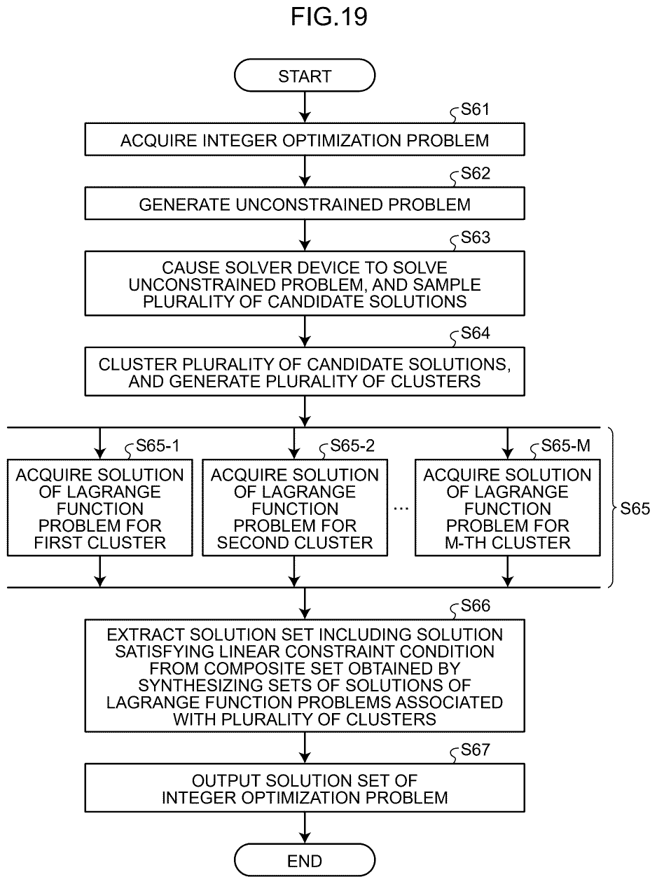

FIG. 19 is a flowchart illustrating a procedure of processing of a processor 12 according to the third embodiment. In the third embodiment, the processor 12 executes a main program stored in a storage device 14, and executes processing in a flow illustrated in FIG. 19.

First, in S61, the processor 12 acquires an integer optimization problem of minimizing an objective function under a linear constraint condition including a plurality of inequality constraint conditions and a target value constraint condition that makes the objective function equal to or more than or equal to or less than a target value.

Subsequently, in S62, the processor 12 generates the unconstrained problem based on the acquired integer optimization problem. That is, the processor 12 generates as the unconstrained problem a problem of minimizing the objective function by removing the linear constraint condition from the acquired integer optimization problem.

Subsequently, in S63, the processor 12 causes the solver device 15 to solve the unconstrained problem to sample a plurality of candidate solutions.

Subsequently, in S64, the processor 12 generates clusters, each including one or more candidate solutions, by clustering the candidate solutions.

Subsequently, in S65, the processor 12 generates a Lagrange function problem for each of the clusters, and calculates a solution to the generated Lagrange function problem. For example, in S65-1, the processor 12 generates a first Lagrange function problem for a first cluster of the clusters, and causes the solver device 15 to obtain a solution to the generated first Lagrange function problem to acquire the solution to the first Lagrange function problem. For example, in S65-M, the processor 12 generates an M-th Lagrange function problem for an M-th cluster of the clusters, and causes the solver device 15 to obtain a solution to the generated M-th Lagrange function problem to acquire the solution to the M-th Lagrange function problem. Note that M represents an integer equal to or more than two indicating the number of the clusters. The processor 12 may execute processing of calculating the solution to the Lagrange function problem for some of or all the clusters in parallel, or may sequentially execute the processing for each cluster.

Subsequently, in S66, the processor 12 extracts one or more solutions that satisfy the linear constraint condition in the integer optimization problem as one or more solutions of the integer optimization problem from a composite solution set obtained by synthesizing the solutions of the Lagrange function problem calculated for each of the clusters.

Furthermore, in S67, the processor 12 outputs the solution set including the extracted one or more solutions as a solution set for the integer optimization problem.

By executing the processing in above S61 to S67, the processor 12 according to the third embodiment can find the solution to the integer optimization problem of minimizing the objective function under the linear constraint condition including the plurality of inequality constraint conditions and the target value constraint condition that makes the objective function equal to or more than or equal to or less than the target value.

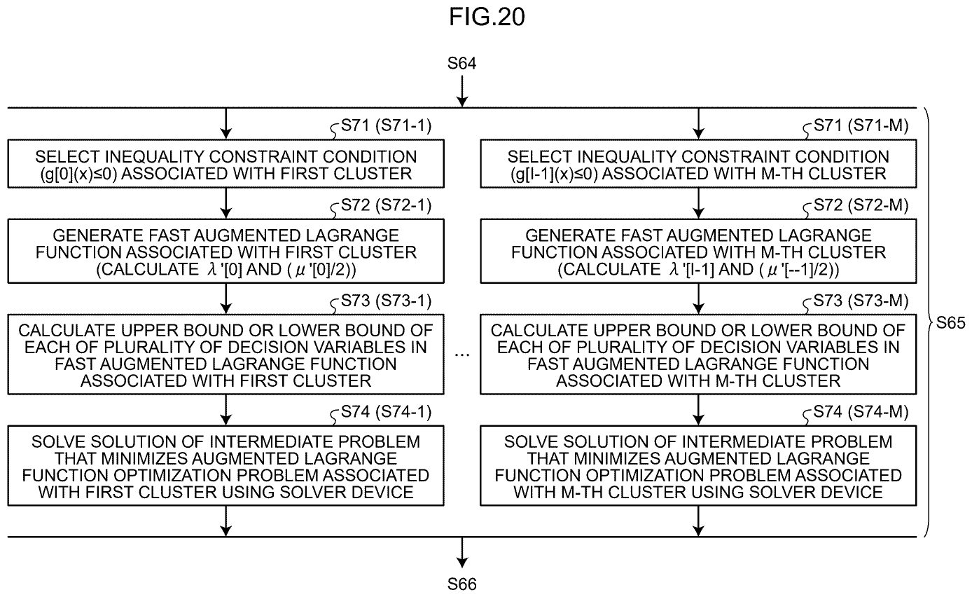

FIG. 20 is a flowchart illustrating a procedure of processing of calculating the solution to the Lagrange function problem for each of the clusters in S65.

In S65, the processor 12 executes the processing in S71 to S74 for each of the clusters. For example, the processor 12 executes the processing in S71-1 to S74-1 for a first cluster of the clusters. Furthermore, the processor 12 executes processing in S71-M to S74-M for the M-th cluster of the clusters.

In S71 (S71-1 to S71-M), the processor 12 selects, as a target inequality constraint condition, an inequality constraint condition in which the corresponding penalty function is close to a target cluster of the clusters among the plurality of inequality constraint conditions in the integer optimization problem.

For example, the processor 12 selects, as the target inequality constraint condition, an inequality constraint condition in which a local minimum point estimated from the target cluster is close to the corresponding penalty function. In this example, the processor 12 selects one inequality constraint condition among the inequality constraint conditions as the target inequality constraint condition. Note that the processor 12 may select two or more target inequality constraint conditions from the inequality constraint conditions.

Subsequently, in S72 (S72-1 to S72-M), the processor 12 executes a parameter calculation program stored in the storage device 14 to generate the fast augmented Lagrange function for the target cluster based on a problem of minimizing the objective function under the linear constraint condition including the selected target inequality constraint condition and the target value constraint condition. For example, when one target inequality constraint condition is selected, the processor 12 executes the same processing as that in S12 in the first embodiment. Furthermore, when two or more target inequality constraint conditions are selected, the processor 12 executes the same processing as that in S42 in the second embodiment.

Subsequently, in S73 (S73-1 to S73-M), the processor 12 executes a pruning program stored in the storage device 14 to calculate an upper bound or a lower bound of a search range in the case of solving the Lagrange function problem of minimizing the fast augmented Lagrange function. For example, when one target inequality constraint condition is selected, the processor 12 executes the same processing as that in S13 in the first embodiment. Furthermore, when two or more target inequality constraint conditions are selected, the processor 12 executes the same processing as that in S43 in the second embodiment.

Subsequently, in S74 (S74-1 to S74-M), the processor 12 gives to the solver device 15 the Lagrange function problem of minimizing the fast augmented Lagrange function generated in S72, and causes the solver device 15 to find one or more solutions to the Lagrange function problem of minimizing the fast augmented Lagrange function.

Furthermore, when solving the Lagrange function problem of minimizing the fast augmented Lagrange function, the processor 12 searches a region between the local minimum neighboring point and the upper bound or the lower bound in the solution space calculated in S73. For example, the processor 12 gives the upper bound or the lower bound of the search range to the solver device 15, and causes the solver device 15 to search the region between the local minimum neighboring point and the upper bound or the lower bound in the solution space by the solving processing of the Lagrange function problem of minimizing the fast augmented Lagrange function.

By executing the above processing, the processor 12 can generate a Lagrange function problem for each of the clusters and calculate a solution to the generated Lagrange function problem.

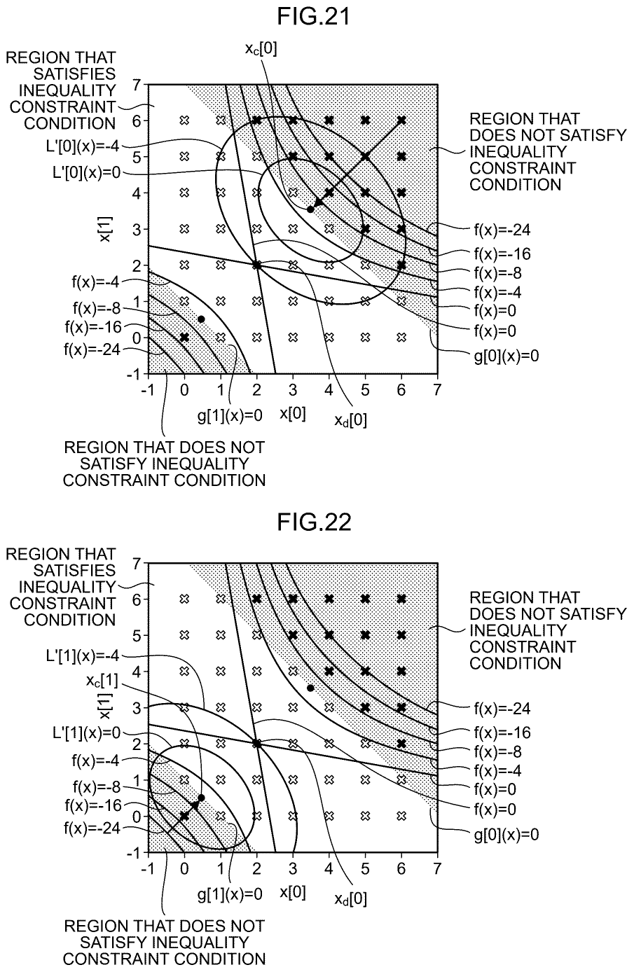

FIG. 21 is a diagram illustrating an example of a solution space that indicates a Lagrange function problem generated in the problem solver apparatus 10 according to the third embodiment and corresponding to the first cluster. FIG. 22 is a diagram illustrating an example of a solution space that indicates a Lagrange function problem generated in the problem solver apparatus 10 according to the third embodiment and corresponding to the second cluster.

For example, it is assumed that the objective function is Formula (71), a first penalty function is Formula (72), a second penalty function is Formula (73), and the target value is Formula (74).

$$f ( x ) = - {( x [ 0 ] + x [ 1 ] - 4 )}^{2} + 0.5 \cdot {( x [ 0 ] - x [ 1 ] )}^{2} \qquad ( 71 )$$

$$g [ 0 ] ( x ) = x [ 0 ] + x [ 1 ] - 7 \qquad ( 72 )$$

$$g [ 1 ] ( x ) = - x [ 0 ] - x [ 1 ] + 1 \qquad ( 73 )$$

$$target = 0 \qquad ( 74 )$$

Furthermore, it is assumed that the processor 12 generates two clusters. It is assumed that the processor 12 selects a first penalty function (g(0)(x)) for the first cluster of the two clusters, and selects a second penalty function (g(1)(x)) for the second cluster of the two clusters.

In the above case, for the first cluster, the processor 12 calculates a vector of Formula (75) as a local minimum neighboring point (x_{c}(0)), a vector of Formula (76) as an allowable choice point (x_{d}(0)), a value of Formula (77) as μ′(0), and a value of Formula (78) as λ′(0).

$${x}_{c} [ 0 ] = ( 3.5 , 3.5 ) \qquad ( 75 )$$

$${x}_{d} [ 0 ] = ( 2. , 2. ) \qquad ( 76 )$$

$${μ}^{′} [ 0 ] = 2. \qquad ( 77 )$$

$${λ}^{′} [ 0 ] = 3. \qquad ( 78 )$$

In this case, the contour of the objective function (f(x)), the contour of the fast augmented Lagrange function (L′(0)(x)) calculated for the first cluster, the first penalty function, and the second penalty function are as illustrated in FIG. 21 in the solution space. As illustrated in FIG. 21, the fast augmented Lagrange function (L′(0)(x)) calculated for the first cluster is close to the boundary at which the local minimum neighboring point (x_{c}(0)) satisfies or does not satisfy a target inequality constraint condition (g(0)(x)≤0) in the region satisfying the constraint condition (the unhatched region of the solution space). Consequently, when the solver device 15 executes the search processing using the fast augmented Lagrange function (L′(0)(x)) calculated for the first cluster, it is possible to narrow the search range, and reduce a time required to obtain an exact solution and a large number of approximate solutions.

Furthermore, the region in which the fast augmented Lagrange function (L′(0)(x)) according to the third embodiment is the target value (L′(0)(x)=0) or less is regions in which the objective function (f(x)) is the target value (f(x)=0) or less and includes all the regions satisfying the constraint conditions (the unhatched regions in the solution space). Accordingly, by executing the search processing within the range of the upper bound or the lower bound of the search range, the solver device 15 does not need to search a range in which the objective function (f(x)) is larger than the target value, and it is possible to reduce the time required to obtain the exact solution and a large number of approximate solutions.

Furthermore, in the above case, for the second cluster, the processor 12 calculates a vector of Formula (79) as a local minimum neighboring point (x_{c}(1)), a vector of Formula (80) as an allowable choice point (x_{d}(1)), a value of Formula (81) as μ′(1), and a value of Formula (82) as λ′(1).

$${x}_{c} [ 1 ] = ( 0.5 , 0.5 ) \qquad ( 79 )$$

$${x}_{d} [ 1 ] = ( 2. , 2. ) \qquad ( 80 )$$

$${μ}^{′} [ 1 ] = 2. \qquad ( 81 )$$

$${λ}^{′} [ 1 ] = 3. \qquad ( 82 )$$

In this case, a contour of the objective function (f(x)), the contour of the fast augmented Lagrange function (L′(1)(x)) calculated for the second cluster, the first penalty function, and the second penalty function are as illustrated in FIG. 22 in the solution space. As illustrated in FIG. 22, the fast augmented Lagrange function (L′(1)(x)) calculated for the second cluster is close to the boundary at which the local minimum neighboring point (x_{c}(1)) satisfies or does not the target inequality constraint condition (g(1)(x)≤0) in the region satisfying the constraint condition (the unhatched region of the solution space). Consequently, when the solver device 15 executes the search processing using the fast augmented Lagrange function (L′(1)(x)) calculated for the second cluster, it is possible to narrow the search range, and reduce a time required to obtain an exact solution and a large number of approximate solutions.

Furthermore, the regions in which the fast augmented Lagrange function (L′(1)(x)) according to the third embodiment is the target value (L′(1)(x)=0) or less are regions in which the objective function (f(x)) is the target value (f(x)=0) or less and include all the regions satisfying the constraint conditions (the unhatched regions in the solution space). Accordingly, by executing the search processing within the range of the upper bound or the lower bound of the search range, the solver device 15 does not need to search a range in which the objective function (f(x)) is larger than the target value, and it is possible to reduce the time required to obtain the exact solution and a large number of approximate solutions.

Furthermore, the problem solver apparatus 10 according to the third embodiment can calculate λ′(i) and μ′(i) that are parameters of the fast augmented Lagrange function (L′(i)(x)) of each of the clusters only by performing calculation processing once without repeatedly calculating λ′(i) and μ′(i) multiple times. Consequently, the problem solver apparatus 10 according to the third embodiment can reduce the time required to obtain the exact solution and the large number of approximate solutions.

As described above, the problem solver apparatus 10 according to the third embodiment can improve a probability of obtaining the exact solution or the large number of approximate solutions and reduce the time required for solving.

The computer program executed by the above-described problem solver apparatus 10 according to the present embodiment can be provided as a computer program product by being recorded as a file in an installable format or an executable format on a non-transitory computer-readable recording medium such as a CD-ROM, a Flexible Disk (FD), a CD-R, or a Digital Versatile Disk (DVD).

Furthermore, the program executed by the problem solver apparatus 10 according to the present embodiment may be configured to be stored in a computer connected to a network such as the Internet, downloaded via the network, and thereby provided. Furthermore, the program executed by the problem solver apparatus 10 according to the present embodiment may be configured to be provided or distributed via the network such as the Internet. Furthermore, the program executed by the problem solver apparatus 10 according to the present embodiment may be configured to be incorporated in a ROM or the like in advance and provided.

The program for causing an information processing device to function as the problem solver apparatus 10 includes the main program, the parameter calculation program, and the pruning program. Furthermore, the program may include a module that implements the solver device 15. When this program is executed by the one or more hardware processors, each module is loaded into a RAM of a memory to cause the one or more hardware processors to function as an acquisition unit 121, a parameter generation unit 122, a pruning unit 123, a problem solving unit 124, an extraction unit 125, and an output unit 126. Furthermore, this program may cause the one or more hardware processors to function as the solver device 15. Note that some of or all these components may be configured as hardware.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A problem solver apparatus, comprising:
a hardware processor connected to a memory, the hardware processor serving to solve an integer optimization problem of minimizing an objective function under a linear constraint condition, the linear constraint condition including one or more inequality constraint conditions and a target value constraint condition that makes the objective function equal to or more than or equal to or less than a target value, wherein
the hardware processor is configured to
acquire the integer optimization problem,
calculate a first parameter to be multiplied on a target penalty function and a second parameter to be multiplied on a square of the target penalty function, the first parameter and the second parameter being calculated for each of one or more penalty functions corresponding to the one or more inequality constraint conditions,
generate a fast augmented Lagrange function obtained by adding the objective function, one or more terms multiplied with the first parameter corresponding to each of the one or more penalty functions, and one or more terms multiplied with the second parameter corresponding to a square of each of the one or more penalty functions,
acquire one or more solutions to a Lagrange function problem of minimizing the fast augmented Lagrange function, and
output, as a solution set for the integer optimization problem, a set of solutions satisfying the linear constraint condition among the one or more solutions to the Lagrange function problem.

2. The problem solver apparatus according to claim 1, wherein
the hardware processor is configured to calculate a local minimum neighboring point and an allowable choice point,
the local minimum neighboring point indicates
a position in a solution space defined by a plurality of decision variables included in the objective function, and
a position at which a value is zero when the local minimum neighboring point is substituted into each of the one or more penalty functions, and at which a value is close to a local minimum of the objective function when the local minimum neighboring point is substituted into the objective function,
the allowable choice point indicates
a position in the solution space defined by the decision variables, and
a position satisfying the one or more inequality constraint conditions and satisfying the target value constraint condition, and
the hardware processor is configured to calculate, for each of the one or more penalty functions, the first parameter that satisfies a condition in which
a value of the fast augmented Lagrange function into which the local minimum neighboring point is substituted and a value of the objective function into which the local minimum neighboring point is substituted are equal to each other, and
a value of the fast augmented Lagrange function into which the allowable choice point is substituted and a value of the objective function into which the allowable choice point is substituted are equal to each other, and
the hardware processor is configured to calculate, for each of the one or more penalty functions, the second parameter whose Jacobian of the fast augmented Lagrange function into which the local minimum neighboring point is substituted is zero or is close to zero.

3. The problem solver apparatus according to claim 2, wherein the hardware processor is configured to
solve a local minimum neighboring point calculation problem of minimizing the objective function in a state where each of the decision variables is converted into a variable of a real number value, the local minimum neighboring point calculation problem being solved under a constraint condition in which each of the one or more penalty functions is set to zero, and
calculate the local minimum neighboring point based on a solution to the local minimum neighboring point calculation problem.

4. The problem solver apparatus according to claim 3, wherein the hardware processor is configured to
solve an allowable choice point calculation problem of minimizing a function obtained by adding a square of each of the one or more penalty functions in a state where each of the decision variables is converted into a variable of a real number value, the allowable choice point calculation problem being solved under a condition in which the value of the objective function is equal to the target value, and
calculate the allowable choice point based on a solution to the allowable choice point calculation problem.

5. The problem solver apparatus according to claim 2, wherein
the hardware processor is configured to calculate an upper bound or a lower bound of a search range for solving the Lagrange function problem in a state where each of the decision variables is converted into a variable of a real number value, the upper bound or the lower bound being calculated based on a solution to a maximization problem of maximizing (e^{T}·x) under a constraint condition in which the value of the fast augmented Lagrange function is equal to or more than the target value,
x represents a variable vector that indicates a position in a solution space defined by the decision variables,
e^{T} represents a transposed matrix of a search direction vector,
the search direction vector indicates a search direction in the solution space for each of one or more decision variables that limit the search range among the decision variables, and
the hardware processor is configured to search a region between the local minimum neighboring point and the upper bound or the lower bound in the solution space when solving the Lagrange function problem.

6. The problem solver apparatus according to claim 1, wherein the hardware processor is configured to
sample a plurality of candidate solutions to an unconstrained problem, the unconstrained problem being obtained by removing the linear constraint condition from the integer optimization problem,
generate clusters, each including one or more candidate solutions, by clustering the candidate solutions,
calculate, for each of the clusters, the first parameter and the second parameter with respect to a penalty function out of the one or more penalty functions,
generate the fast augmented Lagrange function for each of the clusters,
acquire, for each of the clusters, one or more solutions to the Lagrange function problem, and
output, as the solution set for the integer optimization problem, a set of solutions satisfying the linear constraint condition in a composite solution set obtained by synthesizing the one or more solutions acquired for each of the clusters.

7. The problem solver apparatus according to claim 6, wherein the hardware processor is configured to
select, for each of the clusters, a target inequality constraint condition from the one or more inequality constraint conditions, and
calculate, for each of the clusters, the first parameter and the second parameter with respect to the target penalty function corresponding to the target inequality constraint condition.

8. The problem solver apparatus according to claim 2, wherein
the linear constraint condition includes the one or more inequality constraint conditions,
an i-th inequality constraint condition among the one or more inequality constraint conditions is defined by Formula (1)
$$g [ i ] ( x ) \leq 0 , \qquad ( 1 )$$
i represents an integer from zero to (I−1), both inclusive, and indicates an (i+1)-th inequality constraint condition among the one or more inequality constraint conditions,
x represents a vector that indicates a plurality of decision variables included in the objective function, and
a target penalty function corresponding to the (i+1)-th inequality constraint condition among the one or more penalty functions is defined by g(i)(x).

9. The problem solver apparatus according to claim 8, wherein
the fast augmented Lagrange function is defined by Formula (2)
$${L}^{′} ( x ) = f ( x ) + {\sum }_{i ∈ \{ 0 , … , ( I - 1 ) \}} ( {λ}^{′} [ i ] \cdot g [ i ] ( x ) + \frac{{μ}^{′} [ i ]}{2} \cdot g [ i ] {( x )}^{2} ) , \qquad ( 2 )$$
f(x) represents an objective function,
I represents an integer equal to or more than one and represents the number of one or more inequality constraint conditions,
λ′(i) represents the first parameter to be multiplied on a penalty function corresponding to the (i+1)-th inequality constraint condition, and
(μ′(i)/2) represents the second parameter to be multiplied on a square of the penalty function corresponding to the (i+1)-th inequality constraint condition.

10. The problem solver apparatus according to claim 9, wherein
the hardware processor is configured to calculate λ′(i) with Formula (3)
$${λ}^{′} [ i ] = - \frac{{μ}^{′} [ i ]}{2} \cdot ( g [ i ] ( {x}_{c} ) + g [ i ] ( {x}_{d} ) ) , \qquad ( 3 )$$
x_{c} represents the local minimum neighboring point, and
x_{d} represents the allowable choice point.

11. The problem solver apparatus according to claim 10, wherein the hardware processor is configured to calculate μ′(i) based on Formula (4)
$$0 ≃ ∇ f ( {x}_{c} ) + {\sum }_{i ∈ \{ 0 , … , ( I - 1 ) \}} ( + \frac{{μ}^{′} [ i ]}{2} \cdot ( g [ i ] ( {x}_{c} ) - g [ i ] ( {x}_{d} ) ) \cdot ∇ g [ i ] ( {x}_{c} ) ) . \qquad ( 4 )$$

12. The problem solver apparatus according to claim 11, wherein the hardware processor is configured to calculate μ′(i) under a condition in which μ′(i) is equal to or more than zero, μ′(i) being calculated based on a solution to a problem of minimizing an absolute value of a right-hand side of Formula (4) including μ′(i) as a variable.

13. A problem solving method implemented by a computer, the method comprising:
acquiring an integer optimization problem of minimizing an objective function under a linear constraint condition, the linear constraint condition including one or more inequality constraint conditions and a target value constraint condition that makes the objective function equal to or more than or equal to or less than a target value;
calculating a first parameter to be multiplied on a target penalty function and a second parameter to be multiplied on a square of the target penalty function, the first parameter and the second parameter being calculated for each of one or more penalty functions corresponding to the one or more inequality constraint conditions;
generating a fast augmented Lagrange function obtained by adding the objective function, one or more terms multiplied with the first parameter corresponding to each of the one or more penalty functions, and one or more terms multiplied with the second parameter corresponding to a square of each of the one or more penalty functions;
acquiring one or more solutions to a Lagrange function problem of minimizing the fast augmented Lagrange function; and
outputting, as a solution set for the integer optimization problem, a set of solutions satisfying the linear constraint condition among the one or more solutions to the Lagrange function problem.

14. A computer program product comprising a non-transitory computer readable recording medium on which a computer program executable by a computer is recorded, the computer program instructing the computer to perform:
acquiring an integer optimization problem of minimizing an objective function under a linear constraint condition, the linear constraint condition including one or more inequality constraint conditions and a target value constraint condition that makes the objective function equal to or more than or equal to or less than a target value;
calculating a first parameter to be multiplied on a target penalty function and a second parameter to be multiplied on a square of the target penalty function, the first parameter and the second parameter being calculated for each of one or more penalty functions corresponding to the one or more inequality constraint conditions;
generating a fast augmented Lagrange function obtained by adding the objective function, one or more terms multiplied with the first parameter corresponding to each of the one or more penalty functions, and one or more terms multiplied with the second parameter corresponding to a square of each of the one or more penalty functions;
acquiring one or more solutions to a Lagrange function problem of minimizing the fast augmented Lagrange function; and
outputting, as a solution set for the integer optimization problem, a set of solutions satisfying the linear constraint condition among the one or more solutions to the Lagrange function problem.
